(19) United States
(12) Patent Application Publication
(10) Pub. No.: US 2012/0235574 A1
(43) Pub. Date: Sep. 20, 2012

(54) FLUORESCENT LAMP DRIVE AND A PROTECTION CIRCUIT THEREIN

(75) Inventors: Yoshikazu SUMI, MOTOSU-SHI (JP); Takuhiro TANASE, MOTOSU-SHI (JP)

(73) Assignee: LECIP HOLDINGS CORPORATION, GIFU-KEN (JP)

(21) Appl. No.: 13/433,131

(22) Filed: Mar. 28, 2012

Related U.S. Application Data
(63) Continuation-in-part of application No. PCT/JP2010/067054, filed on Sep. 30, 2010.

(30) Foreign Application Priority Data
Oct. 2, 2009 (JP) 2009-230902
Jun. 23, 2010 (JP) 2010-142204
Jul. 5, 2010 (JP) 2010-152612

(51) Int. Cl. H05B 37/03

(52) U.S. Cl. 315/131

(57) ABSTRACT

An LED lighting circuit mounted in a lighting device having LEDs as a light source, the circuit including:
a light emitting unit that includes a plurality of LED circuits for supplying drive currents to a plurality of LEDs connected in series or parallel;
a failure detection unit that detects whether each of the drive currents flowing through the plurality of LED circuits is equal to or larger than a predetermined fault current value for those LED circuits as a whole; and
a failure alert unit that performs a predetermined alert operation if the failure alert unit detects that at least one of the drive currents is equal to or larger than the predetermined fault current value.

### BACKGROUND OF THE INVENTION

1. Field of the Invention

This invention relates to control of lighting fixtures, explaining in detail, a fluorescent lamp drive for controlling lighting of the fluorescent lamp, and the protection circuit of the fluorescent lamp drive.

2. Description of the Related Art

Conventionally, a fluorescent lamp (a fluorescent tube) 81 as shown in FIG. 23 has been used as an indoor light for such as railroads widely. The fluorescent lamp 81 is a light implement which lets the ultraviolet rays occurring by electric discharge into the phosphor in a tube and converts the rays into the visible light and outputs. A fluorescent lamp drive 82 that controls turning on and off of the fluorescent lamp 81 is connected to the fluorescent lamp 81. An inverter 83 and a transformer 84 is disposed in the fluorescent lamp drive 82. The fluorescent lamp drive 82 changes the inputted direct-current voltage into alternating current voltage with the inverter 83. The fluorescent lamp drive 82 also boosts the alternating current voltage by the transformer 84 and turns on the fluorescent lamp 81 with the boosted high frequency alternating current voltage.

By the way, if the fluorescent lamp 81 comes to its end of product life, it is also assumed that filament wiring of the fluorescent lamp 81 will be disconnected.

In that case, the light may be switched on even if it applies voltage to the fluorescent lamp 81 from the fluorescent lamp drive 82 when the lamp was driven by a high frequency alternating current. Since unusual electric discharge may occur in fluorescent lamp 81 inside, and cause an exothermic accident on rare occasions, the fluorescent lamp drive 82 has to be suspended at the end of life of the fluorescent lamp 81. The fluorescent lamp drive 82 may carry the protection function (refer to the U.S. Pat. No. 6,504,318) which monitors the sign of disconnection. As shown in FIG. 24, the technology of the U.S. Pat. No. 6,504,318 sends through a secondary side of the transformer 84 the direct current Ix which flows into the fluorescent lamp 81, and monitors the sign of the disconnection of the fluorescent lamp 81 by this direct current Ix.

On the other hand, when heating of the filament before lighting runs short, the fluorescent lamp 81 may not start electric discharge, even if it becomes lighting starting potential, or the emitter of a filament disperses and it may shorten the life of an electric discharge lamp. For this reason, preheating control to heat a filament beforehand before a lighting start is performed.

For example, “the capacitor preheating system” as preheating control has been used conventionally. The system makes it possible to preheat the filament by connecting the series resonance circuit by a capacitor with an inductor between the power supply side terminals of a pair of filaments, connecting the capacitor for preheating between the non-power supply side terminals of a filament, and sending the resonance current by such a series resonance circuit through a filament through the capacitor for preheating at the time of preheating before a lighting start.

Moreover, “the electric discharge lamp lighting equipment” disclosed by the Japanese Patent Publication No. 2006-59622 is equipped with preheating mode and starting mode. The preheating mode enables preheating before starting lighting by the preheating power supply circuit which shifts to the starting mode after heating a filament to the target temperature to emit a thermal electron.

On the other hand, there is a light emitting diode lighting fixture comprising many light emitting diodes connected as a light source for such as an interior light implements of a train. In the light emitting diode lighting fixture, when failure in short circuit mode occurs in a light emitting diode, there might be inducing failure of a drive current feed section or light emitting diodes other than the light emitting diode which carried out short circuit failure, because not only the broken light emitting diode but the current which flows into other light emitting diodes also increased. For example, an over-current may be flowed and damage other light emitting diodes connected to the light emitting diode which carried out short circuit failure in series.

Besides, as an interior lighting fittings for use in railways etc., a light emitting diode (LED) lighting device is available in which a lot of LEDs are connected to make up a light source. In such an LED lighting device, if the LED encounters a short-circuit mode failure, not only this faulty LED but also the other LEDs have an increased current flowing through them, so that it may possibly trigger a trouble on those LEDs other than that which initially failed due to the short-circuit failure or a drive current supply unit etc. For example, an overcurrent may possibly flow through and damage those LEDs connected in series to that which initially failed due to the short-circuit failure.

In contrast, Japanese Patent Application Laid-Open No. 1109-327120 discloses a technology that utilizes properties that the damage of the diode would eliminate power dissipation caused by its internal impedance to inhibit heat generation of the diode, to detect a failure of the diode by monitoring a rise in temperature of the diode by using a temperature sensor mounted in the circuit.

However, since the technology of the U.S. Pat. No. 6,504,318 directly sends the direct current Ix for detection of disconnection through the secondary side of the transformer 84, the high frequency alternating current voltage which should come out of the secondary side of the transformer 84 will be affected by the bias magnetism caused by the direct-current current Ix. As shown in FIG. 25, the bias magnetism means the phenomenon that the voltage of a round term of high frequency alternating current voltage superimposes by a direct-current component, and is inclined and outputted with each half cycle. There has been a demand to detect the disconnection while making the fluorescent lamp 81 turned on efficiently, since the electric power will be lost when a secondary side of the transformer 84 is magnetically biased.

On the other hand, the resonance current supplied from the series resonance circuit at the time of the usual lighting will be sent through a filament by the “the capacitor preheating system” during preheating. Since there is a tendency that the tube voltage during preheating become high and the fluorescent lamp lights up before reaching sufficient temperature, the emitter of a filament may disperse.

Moreover, “the electric discharge lamp lighting equipment” in the patent documents 2 requires to prepare the preheating power supply circuit for exclusive use which heats filaments during the preheating mode. Due to such a preheating power supply circuit, the circuit composition becomes complicated, and the number of the circuit components of the transformer T1, the capacitors C2 and C3, the inductor L2, and L3 increases, and the equipments become enlarged.

Additionally, by the diode failure detection circuit described in Japanese Patent Application Laid-Open No. H09-327120, a voltage or current would not directly be detected, so that even if the temperature would fall due to a cause other than the LED failure, the diode might possibly be detected faulty, thereby degrading accuracy in failure detection. Further, in the case of detection only by use of a temperature sensor, it has been impossible to decide whether the failure has been caused by disconnection or short-circuiting. In the case of the failure due to short-circuiting, as described above, generation of the overcurrent may possibly trigger a trouble on the other LEDs, so that there has been a desire for detecting the short-circuit failure securely.

### SUMMARY OF THE INVENTION

The first subject of the present invention is to enable proper preheating with comparatively simple composition, the second subject is to offer the protection circuit of the fluorescent lamp drive which can be efficient and can make a fluorescent lamp turn on, detecting the existence of disconnection, and the third subject of this invention is to offer a lighting fixture equipped with a light emitting diode lighting circuit and the circuit equipped with a failure detection circuit which detects short circuit failure with high precision. And it is aiming at attaining at least one of the subjects of these.

In order to solve the first subject of the above, the present invention features a protection circuit of the fluorescent lamp drive. The fluorescent lamp drive changes the input voltage into the alternating current voltage of high frequency by a transformer, and makes a fluorescent lamp turn on with the alternating current voltage. The protection circuit comprises a direct-current interception means to be connected to a secondary side of the transformer and to cut the direct-current in the current loop circuit of the fluorescent lamp on the secondary side of the transformer. The protection circuit also comprises a detecting disconnection means to monitor the current of the current loop circuit where the direct-current interception means is connected, and to detect whether disconnection arose in this circuit, and a lighting stop means which makes improper lighting operation of the fluorescent lamp when the disconnection is detected.

Both the direct-current voltage obtained, for example from a direct-current battery etc. and the exchange power supply obtained from commercial electric power (system) shall be included in a broad sense with “input voltage” as a definition. When this input voltage is direct-current voltage, needless to say, it is used changing into alternating current voltage. Moreover, as a definition, “current loop circuit” means the closed loop circuit of the current which flows through the fluorescent lamp when the fluorescent lamp turns on.

According to this arrangement, a direct-current interception means is disposed in the current loop circuit connected with the fluorescent lamp. And the direct-current component interception means detects disconnection in the current loop circuit by a detecting disconnection means. Upon detection of disconnection in the current loop circuit connected with the fluorescent lamp, there is no need to use the detecting disconnection procedure which sends direct current directly to the secondary side of the transformer. By the way, the system which sends direct-current current directly and detects disconnection to a secondary side of the transformer makes the secondary side output of a transformer get magnetically biased. It causes a problem that the fluorescent lamp doesn't illuminate efficiently. However, since the direct-current interception means newly configured controls the occurrence of the magnetic bias in the secondary side of the transformer, the disconnection is detected free from the magnetic bias in the secondary side of the transformer. Therefore, it becomes possible to make a fluorescent lamp turn on efficiently, monitoring the disconnection of a fluorescent lamp simultaneously.

In the present invention, the protection circuit of the fluorescent lamp drive may further comprise a voltage monitoring means to monitor the voltage which occurs in the fluorescent lamp, and a lighting termination means to force lighting operation of the fluorescent lamp to terminate, when the voltage becomes equal to or more than a threshold value and abnormalities occur in the fluorescent lamp.

According to this composition, the problems in the fluorescent lamp become detectable, since the voltage rise of the fluorescent lamp causing the filament down at the end of life and tube breakage can be detected, if the voltage in the fluorescent lamp is monitored.

In the present invention, the voltage monitoring means may consist of resistance.

According to this composition, if a voltage monitoring means is resistance, the simple work of changing resistance into the thing of other resistance, or extending a resistance according to the kind of fluorescent lamp to be used, will enable it to change a disregard level easily.

In the present invention, the protection circuit of the fluorescent lamp drive may further comprise an overheating detection means to detect the generating heat of the fluorescent lamp drive, and an overheating control means to force lighting operation of the fluorescent lamp to terminate, when the generating heat becomes equal to or more than a threshold value.

According to this composition, a fluorescent lamp drive can be protected from overheating, since lighting operation of the fluorescent lamp by a fluorescent lamp drive is forced to terminate when a fluorescent lamp drive is overheated.

In the present invention, the protection circuit of the fluorescent lamp drive may further comprise a lighting control means to manage control of turning on and off of the fluorescent lamp. The lighting control means consists of analog circuitry where the state of an output signal changes continuously corresponding to the change of the continuous input signal.

According to this composition, the control circuit unit becomes simplified, since the control circuit unit of the fluorescent lamp drive essentially consists of analog circuitry.

In the present invention, the protection circuit of the fluorescent lamp drive may further comprise a lighting control means comprising a software circuit which operates by the program stored in the memory.

According to this composition, operation of lighting of the fluorescent lamp can be switched by changing the program of a software circuit with other programs, since the control circuit unit of the fluorescent lamp drive is constituted of the software circuit. Therefore, the lighting operation can be easily changed to another operation easily without changing the fluorescent lamp drive physically.

Moreover, in order to solve the second subject, according to the present invention, the input circuit may be an inverter circuit which changes direct-current voltage into high frequency alternating voltage. The circuit is constituted including an inductor and a capacitor. The inductor is connected in series between each power supply side terminal of a pair of filaments of the fluorescent lamp, and the capacitor is connected between the non-power-supply side terminals of the pair of filaments. The circuit is a series resonance circuit that is set to the resonance frequency for lighting of the fluorescent lamp.

According to the present invention, it comprises a capacitor that is connected between the inductor in a series resonance circuit necessary for the normal lighting control, and the non-power supply side terminal of a pair of filaments. It also adds an analogue switch parallel to the capacitor. The analog switch is controlled by a switch control circuit to ON during the preheating period before lighting of a fluorescent lamp, and after a preheating period the switch is controlled to OFF, respectively. During the preheating period when an analog switch is set to ON, the non-power supply side terminals will be in a short circuit state with an analog switch, though the capacitor is connected between the non-power supply side terminals of a filament. Thus, a pair of filaments change the power supply side terminals into an electrical connection state in direct current each other via the non-power supply side terminals. Therefore, the preheating control to heat the filament beforehand is attained without making the fluorescent lamp turn on before the lighting start by comparatively simple arrangement comprising additionally the analog switch and the switch control circuit to control the analog switch, since the fluorescent lamp does not light up even if it impresses high frequency voltage to the filament during the preheating.

Moreover, according to the fluorescence lamp drive of the present invention, it may further comprise a frequency control circuit controlling the frequency of the high frequency alternating voltage, wherein the frequency control circuit sets the frequency of the high frequency alternating voltage in the preheating period higher than the frequency, as not less than 50 kHz or less higher than 100 kHz, after the preheating period. Since the high frequency voltage of 50 to 100 kHz is impressed to the filament which changed into the electrical connection state in direct current during the preheating, the fluorescent lamp can be preheated for a short period of time.

Furthermore, according to the fluorescence lamp drive of the present invention, the control terminal of the analog switch is electrically insulated by the photocoupler to the power supply line of the fluorescent lamp and its peripheral circuitry with which the high frequency voltage is supplied. Since it is not likely to be influenced by the high frequency noise which may occur from the power supply line and the peripheral circuitry of the fluorescent lamp even if the input impedance of the control terminal of the analog switch is comparatively high, malfunction by such a noise can be prevented.

Furthermore, according to the fluorescent lamp drive of the present invention, the switch control circuit may include the damping time constant circuit which determines the preheating period with the value of resistance and a capacitor. A preheating period can be easily set up because this changes the value of such resistance or a capacitor suitably.

Additionally, to solve the third problem, fourth through seventh embodiments will be described as follows. Those each provide an LED lighting circuit mounted in a lighting device having LEDs as a light source, the circuit including a light emitting unit that includes a plurality of LED circuits which supply drive currents to a plurality of the LEDs connected in parallel or serial, a failure detection unit that detects whether each of the drive currents flowing through the plurality of LED circuits is equal to or larger than a predetermined fault current value for those LED circuits as a whole, and a failure alert unit that performs a predetermined alert operation if the failure detection unit detects that at least one of the drive currents is equal to or larger than the predetermined fault current value.

By those fourth through seventh embodiments, the failure detection unit detects whether each of the drive currents flowing through the plurality of LED circuits is equal to or larger than a predetermined fault current value for those LED circuits as a whole and, if at least one of them is equal to or larger than the predetermined fault current value, the failure alert unit performs the predetermined alert operation.

Accordingly, if any LED in the LED circuit encounters a short-circuit failure, the internal impedance of the LED circuit falls to increase the drive current up to at least the fault current value so that the predetermined alert operation may be performed by the failure alert unit, thereby enabling detecting such a short-circuit failure. Therefore, it is possible to detect the occurrence of a short-circuit failure at high accuracy.

Further, in the LED lighting circuits of those fourth through seventh embodiments, for the plurality of LED circuits as a whole, the failure detection unit may employ a configuration in which it includes a first resistor that is connected in series with the LED circuit so that the drive current may flow through itself, a second resistor that is connected to a higher-potential side of the first resistor so that it can take out a voltage which occurs across the first resistor owing to the drive current, and a detection unit that detects whether a detected voltage which is proportional to the drive current and determined by the first resistor and the second resistor is equal to or larger than a predetermined voltage value, in which the detection unit detects that the drive current is equal to or larger than the fault current value if the detected voltage is equal to or larger than the predetermined voltage value.

In this configuration, the detection unit detects whether the detected voltage which is proportional to the drive current and determined by the first resistor and the second resistor is equal to or larger than the predetermined voltage value and, if it is equal to or larger than the predetermined voltage value, decides that the drive current is equal to or larger than the fault current value. In a case where any LED in the LED circuit encounters a short-circuit failure, if the resistance value of the LED circuit falls to increase the drive current, the detected voltage which is proportional to the drive current and determined by the first resistor and the second resistor increases, so that if this detected voltage is equal to or larger than the predetermined voltage value, it is detected that this drive current is equal to or larger than the fault current value. Accordingly, by combining the resistance values of the first resistor and the second resistor, the detected voltage can be determined, so that the minimum number of the short-circuit-failed LEDs required to operate the failure alert unit can be set easily by combining those resistors.

Further, in the LED lighting circuits of those fourth through seventh embodiments, the detection unit may employ a configuration in which it is a semiconductor switching element that includes a control terminal, an input terminal, and an output terminal, in which if the detected voltage input to the control terminal is equal to or larger than a predetermined threshold voltage, the state of continuity is established between the input terminal and the output terminal, whereas if the detected voltage is less than the predetermined threshold voltage, the state of non-continuity is established between the input terminal and the output terminal.

If this semiconductor switching element is a bipolar transistor, the “control terminal” is a base, the “input terminal” is a collector, and the “output terminal” is an emitter. If this semiconductor switching element is a field effect transistor, the “control terminal” is a gate, the “input terminal” is a drain, and the “output terminal” is a source. The type of the semiconductor switching element is not limited and may be selected arbitrarily.

In this configuration, the detection unit is a semiconductor switching element that includes the control terminal, the input terminal, and the output terminal, in which if the detected voltage input to the control terminal is equal to or larger than the predetermined threshold voltage, it establishes the state of continuity between the input terminal and the output terminal and, if the detected voltage is less than the predetermined threshold voltage, establishes the state of non-continuity between the input terminal and the output terminal. In a case where any LED in the LED circuit encounters a short-circuit failure, if the internal impedance of the LED circuit falls to increase the drive current, the detected voltage which is proportional to the drive current and determined by the first resistor and the second resistor also increases, so that if this detected voltage is equal to or larger than the predetermined threshold voltage, it establishes the state of continuity between the input terminal and the output terminal and decides that “the drive current is equal to or larger than the fault current”. In such a manner, whether the drive current is equal to or larger than the fault current can be detected by turning on/off the semiconductor switching element, so that an alert operation of the failure alert unit can be controlled by this semiconductor switch.

Further, in the LED lighting circuits of those fourth through seventh embodiments, the failure alert unit may employ a configuration in which it includes a warning display LED which indicates alert status and lights the warning display LED as the predetermined alert operation.

In this configuration, if the failure alert unit operates, the warning display LED is lit, so that it is possible to give warning in a visually recognizable manner by using a simple configuration.

Further, in the LED lighting circuits of those fourth through seventh embodiments, the failure alert unit may employ a configuration in which it includes a photo-coupler which is connected to the drive current supply unit supplying the drive currents so that it can output a control signal that decreases the drive currents and permits the photo-coupler to output the control signal as the predetermined alert operation.

In this configuration, if the failure alert unit operates, the control signal that decreases the drive currents is output from the photo-coupler, so that by decreasing the increased drive currents, it is possible to prevent an overcurrent from flowing through normal LEDs.

In the lighting device including any one of the LED lighting circuits of those fourth through seventh embodiments, if any LED in the LED circuit encounters a short-circuit failure, the internal impedance of the LED circuit falls to increase the drive current. Accordingly, if this increased drive current becomes equal to or larger than the fault current value, the predetermined alert operation is performed by the failure alert unit, so that such a short-circuit failure can be detected.

Therefore, if the LEDs that make up the light source of the lighting device encounter a short-circuit failure, the failure detection unit incorporated in the lighting device detects the failure, and based on a result of the detection, the failure alert unit can perform the failure alert operation to enable suggesting the need to repair or replace the lighting device comparatively early, so that it is possible to prevent an overcurrent due to the short-circuit failure from further expanding hazards of the failure.

As described hereinabove, the failure detection unit can detects whether each drive current flowing through the plurality of LED circuits is equal to or larger than the predetermined fault current value for those LED circuits as a whole, so that it is possible to provide an LED lighting circuit and lighting device that can detect a short-circuit failure on the LEDs in the LED circuit at high accuracy.

According to the present invention, a fluorescent lamp can be turned on efficiently, while the disconnection can be detected simultaneously. Moreover, the fluorescent lamp drive can be provided which enables preheating control to heat the filament beforehand is attained by comparatively simple arrangement comprising an analog switch and a switch control circuit to control the analog switch.

### BRIEF DESCRIPTION OF DRAWINGS

FIG. 1 is a diagram depicting the configuration of the first embodiment of the fluorescent lamp drive according to the present invention.

FIG. 2 (A) is a block diagram depicting the component about preheating control the fluorescent lamp drive in FIG. 1.

FIG. 2 (B) is a block diagram showing an example of composition with a photocoupler.

FIG. 3 is a time chart at the time of normal lighting without disconnection and abnormality.

FIG. 4 is a time chart at the time of occurring disconnection.

FIG. 5 is a time chart at the time of occurring abnormality in the tube.

FIG. 6 is a schematic diagram depicting the structure of the fluorescent lamp drive in the second embodiment.

FIG. 7 is a time chart at the time of normal lighting without disconnection and abnormality in the third embodiment.

FIG. 8 is a time chart at the time of occurring disconnection in the third embodiment.

FIG. 9 is a time chart at the time of occurring abnormality in the tube in the third embodiment.

FIG. 10 is a combination of views of the first fluorescent lamp socket which constitutes the socket set for a fluorescent lamp.

FIG. 11 is a perspective view of the first fluorescent lamp socket.

FIG. 12 is a cross sectional view of the socket in FIG. 10 at the AA line.

FIG. 13 is a combination of views of the second fluorescent lamp socket which constitutes the socket set for a fluorescent lamp.

FIG. 14 is a perspective view of the second fluorescent lamp socket.

FIG. 15 is a cross sectional view of the socket in FIG. 13 at the BB line.

FIG. 16 is a block diagram showing a configuration of the LED lighting device.

FIG. 17 is a circuit diagram showing main units of an LED lighting circuit in the fourth embodiment.

FIG. 18 is a circuit diagram showing a main part of the fifth embodiment.

FIG. 19 is a circuit diagram showing a configuration of the LED lighting circuit in the fifth embodiment.

FIG. 20 is a circuit diagram showing a main part of the sixth embodiment.

FIG. 21 is a circuit diagram showing a main part of the seventh embodiment.

FIG. 22 is a circuit diagram showing a configuration of the tube failure detection circuit in another example of the present invention.

FIG. 23 is a circuit diagram showing the composition of the prior art of the fluorescent lamp drive.

FIG. 24 is a schematic diagram showing the structure of the prior art of the fluorescent lamp drive equipped with the protection function.

FIG. 25 is a wave form chart showing an example of the high frequency alternating current voltage impressed to a fluorescent lamp.

### DESCRIPTION OF THE PREFERRED EMBODIMENTS

### The First Embodiment

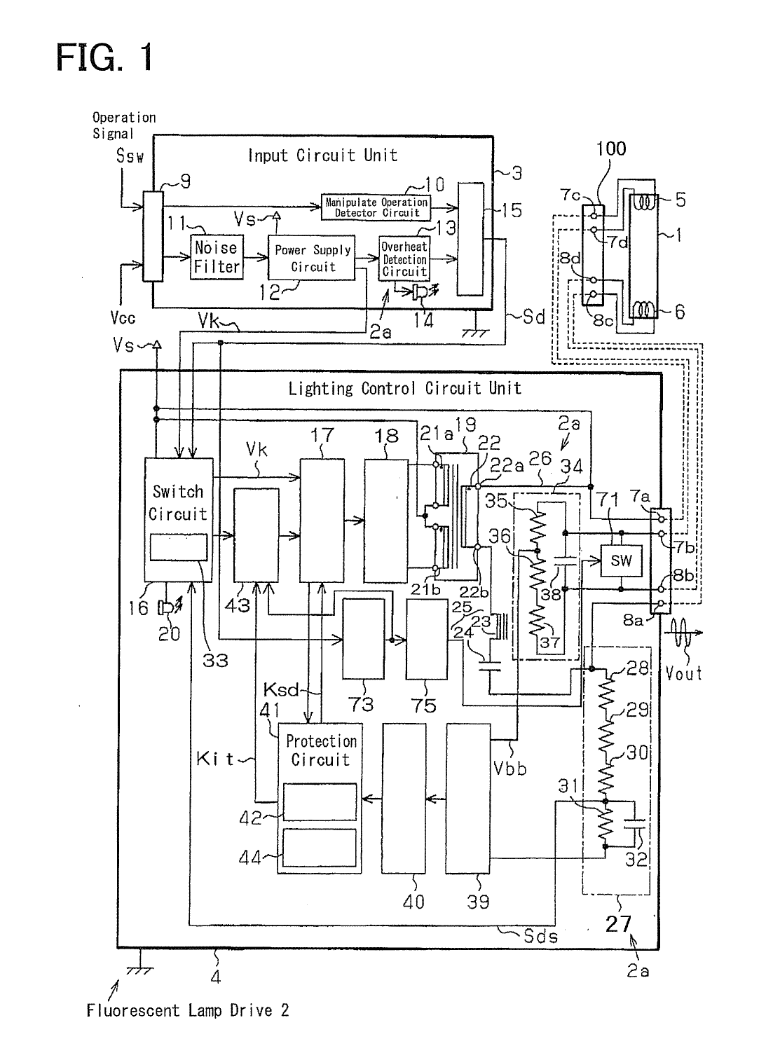

Hereafter, the first embodiment of the protection circuit of the fluorescent lamp drive which materialized the present invention is explained according to the FIG. 1 to FIG. 5.

First, a fluorescent lamp 1 which is controlled its power ON and OFF with the fluorescent lamp drive 2 concerning the first embodiment is described.

As shown in FIG. 1, the fluorescent lamp 1 is a cylindrical type fluorescent lamp, and a pair of filaments are formed on the connectors fixed to the opposite ends, respectively.

Concerning a filament 5, one of them, the first terminal (power supply side terminal) of the first filament 5 is configured to connect electrically to the first contact button 7a of the lighting control circuit unit 4 via the power supply side contact button 7c prepared in the fluorescent lamp attachment 100. And the second terminal (non-power supply side terminal) is configured to connect electrically to the first contact button 7b of the lighting control circuit unit 4 via the non-power supply side contact button 7d.

Likewise, the other filament 6 is electrically connected to the second contact button 8a of the lighting control circuit unit 4 through the power supply side contact button 8c in which the end side (power supply side terminal) was prepared in the fluorescent lamp attachment 100, and the other end side (non-power supply side terminal) is electrically connected to the second contact button 8b of the lighting control circuit unit 4 via the non-power supply side contact button 8d, respectively.

The fluorescent lamp drive 2 which controls operation of lighting is connected to the fluorescent lamp 1 configured as mentioned above. The fluorescent lamp drive 2 comprises an input circuit unit 3 which changes the power supply voltage Vcc obtained from the external energizer into a predetermined value, and a lighting control circuit unit 4 which changes the direct voltage which generated in the input circuit unit 3 into the high frequency alternating current voltage (hereafter “high frequency voltage”) Vout and outputs it to the fluorescent lamp 1.

Input Circuit Unit 3

The input terminal 9 into which the power supply voltage Vcc is inputted is formed in the input circuit unit 3. The manipulate signal Ssw of the power switch is inputted into this input terminal 9 in addition to the power supply voltage Vcc from an external power supply. The power switch is operated when turning on or switching off the fluorescent lamp 1. If the ON operation of the power switch is carried out, the ON signal which shows an ON state will be inputted as the manipulate signal Ssw. And if OFF operation of the power switch is carried out, the OFF signal which shows an OFF state will be inputted as the manipulate signal Ssw. The ON/OFF operation of this power switch is detected by the manual operation detector circuit 10 of the input circuit unit 3.

The input circuit unit 3 comprises a noise filter 11 that removes the noise contained in the power supply voltage Vcc, and a power supply circuit 12 that generates the power supply voltage for the lighting control circuit unit 4 from the power supply voltage Vcc as a source of voltage after the noise reduction. The power supply circuit 12 outputs the power supply voltage Vcc, after noise reduction, to the lighting control circuit unit 4 as the main voltage Vs of a lighting power supply of the fluorescent lamp 1, and lowered it to the direct-current voltage of a predetermined value as the reference voltage Vk for the lighting control circuit unit 4 to operate.

Moreover, the input circuit unit 3 comprises an overheating detection circuit 13 which can detect overheating in the input circuit unit 3 for overheat protection function. For example, the circuit is constituted so that a thermo sensitive register detects temperature changes. In this embodiment, it enables to detect heating of the fluorescent lamp 1. The detection of overheating is notified by lighting (at the time of un-detecting) and putting out lights (at the time of detection) of the overheating notification unit 14 which consist of light emitting elements, such as LED connected to the overheating detection circuit 13, so that visual confirmation is possible. This overheat protection function is a part of the function of the protection circuit 2a which protects the fluorescent lamp drive 2.

Furthermore, the input circuit unit 3 comprises the signal output circuit 15 which outputs the actuating signal Sd based on the detection result of the manual operation detector circuit 10 and the overheating detection circuit 13 to the lighting control circuit unit 4. This signal output circuit 15 outputs a lighting demand (ON signal) to the lighting control circuit unit 4 as the actuating signal Sd, when the manual operation detector circuit 10 detects power supply ON operation and the overheating detection circuit 13 has not detected overheating. The circuit 15 also outputs a putting-out-lights demand (OFF signal) to the lighting control circuit unit 4 as the actuating signal Sd, when the manual operation detector circuit 10 detected power off operation, or when the overheating detection circuit 13 is detecting overheating.

Lighting Control Circuit Unit 4

The lighting control circuit unit 4 comprises a switch circuit 16 which manages power supply turning on and off of the lighting control circuit unit 4, a oscillating circuit 17 oscillated by PWM control, a inverter circuit 18 which consists of a push pull circuit, and a transformer 19 which raises the voltage of input voltage.

When the reference voltage Vk is inputted from the power supply circuit 12 of operation and the ON signal is inputted as the actuating signal Sd from the signal output circuit 15, the switch circuit 16 outputs the reference voltage V1 to the oscillating circuit 17, and operates the oscillating circuit 17. Thereby, even if the reference voltage Vk is inputted from the power supply circuit 12 of operation, the oscillating circuit 17 is kept halting, when the OFF signal is inputted as the actuating signal Sd from the signal output circuit 15.

The operation notice unit 20 which notifies whether the lighting control circuit unit 4 can operate or not is connected to the switch circuit 16. The operation notice unit 20 consists of LED, and is turned on when the fluorescent lamp 1 is on by the operation of the lighting control circuit unit 4. The operation notice unit 20 goes out, when the fluorescent lamp 1 is off.

The disconnection monitoring unit 33 which monitors disconnection of the fluorescent lamp 1 as a disconnection detection based on the detection signal Sds outputted from the disconnection detecting circuit 27 is established in the switch circuit 16. The disconnection Monitoring Department 33 monitors whether the detection signal Sds becomes no more than the threshold value. When the detection signal Sds becomes no more than a threshold value, the disconnection monitoring unit 33 judges that disconnection has arisen in the fluorescent lamp 1, and stops the supply of the reference voltage Vk to the oscillating circuit 17 from the switch circuit 16. Thereby, the disconnection monitoring unit 33 prevents lighting operation of the lighting control circuit unit 4 under a disconnection situation. The disconnection detection is one of the functions of the protection circuit 2a which protects the fluorescent lamp drive 2.

The oscillating circuit 17 generates a predetermined high frequency signal, and has a function which turns on/turns off by turns the switching element (not shown) in the inverter circuit 18 connected to the oscillating circuit 17 concerned. With this enforcement form, oscillating frequency is switched by the oscillation change circuit 43 connected to the oscillating circuit 17 concerned.

The oscillation change circuit 43, coupled with the preheating time setting circuit 73 mentioned later, is equivalent to the “frequency control circuit” of the present invention. As mentioned later, the fluorescent lamp 1 oscillates the oscillating circuit 17 on high frequency (for example, about 100 kHz) before lighting in order to make the first filament 5 and the second filament 6 generate heat for preheating. After the preheating period, the fluorescent lamp 1 oscillates on frequency (for example, about 40 kHz) comparatively low for the normal lighting. The shortage of heating of the filament before lighting is prevented by the operation. The preheating control is performed by the preheating control circuit unit mentioned later.

The inverter circuit 18 is, for example, a push pull circuit which comprises two switching elements (for example, MOSFET) connected in series, and inputs the high frequency signal outputted from the oscillating circuit 17 into a control (gate) terminal so that it may become negative phase mutually. Thus, the inverter circuit 18 turns on and off these switching elements by turns. Therefore, current is sent alternately to a pair of primary winding 21a and 21b of the transformer 19 connected to the inverter circuit 18. The high frequency voltage Vout occurs on the secondary winding 22 of the transformer 19 and makes the fluorescent lamp 1 turn on. The resonance frequency at the time of the fluorescent lamp 1 lighting up is set up by the secondary winding 22 and the inductance of the choke coil 23, and the capacitance of the capacitor 38 (mentioned later).

The transformer 19 consists of a pair of primary winding 21a and 21b, and the one secondary winding 22, as mentioned above. The first winding terminal 22a of the secondary winding 22 is connected to the terminal 7a (hereinafter “the first contact button 7a of one side”) of one side of the first contact button 7a and 7b. The second winding terminal 22b of the secondary winding 22 is connected to the second contact button 8a of one side of the second contact button 8a and 8b. The first contact button 7a of one side is connected to the principal voltage Vs, and the second contact button 8a of one side is connected to the principal voltage Vs through the secondary winding 22 of the transformer 19. The series circuit 25 of the choke coil 23 and the capacitor 24 for direct-current interception is connected between the second contact button 8a of one side, and the second winding terminal 22b.

The choke coil 23 makes the inductance by the secondary side of the transformer 19 increase. Thereby, the amount of winding of the secondary winding 22 of the transformer 19 is reduced. The secondary winding 22 and the choke coil 23 of the transformer 19 may be equivalent to “the inductor connected in series between the power supply side terminals” of the present invention.

The capacitor 24 for direct-current interception keeps direct current from flowing through it by cutting the direct-current component. There is a closed circuit from the secondary winding side of the transformer 19 to the second filament 6 of the fluorescent lamp 1 and the choke coil 23, via the first filament 5 of the fluorescent lamp 1 and the resistance 35, 36, and 37, as the current loop circuit 26 of the fluorescent lamp 1. The direct current is kept from flowing into the current loop circuit 26. This current loop circuit 26 is corresponding to the “series resonance circuit” of the present invention.

In this embodiment, the disconnection detecting circuit 27 is connected to this current loop circuit 26. The disconnection detecting circuit 27 consists of a circuit which carried out series connection of two or more resistance 28, 29, 30, and 31, and outputs the detection signal Sds which is a voltage according to the current value which flows through the current loop circuit 26 to the switch circuit 16. As mentioned above, the disconnection monitoring unit 33 of the switch circuit 16 monitors whether the detection signal Sds becomes equal to the threshold value or less. The disconnection monitoring unit 33 will determine that disconnection has occurred for the turning-on-electricity course which connects the fluorescent lamp 1, when the detection signal Sds becomes equal to the threshold value or less.

The resistance 35, 36, and 37 are connected in series between the first contact button 7b of the other side of the first contact button 7a and 7b, and the second contact button 8b of the other side of the second contact button 8a and 8b. The resistance 35, 36, and 37 constitutes the tube failure detection circuit 34 which detects the filament piece and tube breakage of the fluorescent lamp 1.

The tube failure detection circuit 34 brings about the tube breakage detection function which is one of the functions of the protection circuit 2a which protects the fluorescent lamp drive 2. The failure detection circuit 34 monitors the voltage between the first filament 5 and the second filament 6 of the fluorescent lamp 1, and detects malfunction. In this embodiment, the tube failure detection circuit 34 outputs the partial voltage Vbb which is observed from the first filament 5 side and occurs between the first resistance 35 and the second resistance 36 as voltage between the filaments 5 and 6. Besides, the capacitor 38 which determines the resonance frequency at the time of the fluorescent lamp 1 lighting up between the first contact button 7b and the second contact button 8b is connected. This capacitor 38 is equivalent to the “capacitor” of the present invention.

The filter circuit 39 which removes direct-current voltage from the partial voltage Vbb of the tube failure detection circuit 34 is connected to the tube failure detection circuit 34. The filter circuit 39 removes direct-current voltage from this partial voltage Vbb, and makes it only alternate-current voltage. The partial voltage Vbb is transferred into the direct-current voltage of a steady value by rectifying in the rectification circuit 40.

The protection circuit 41 which performs the protection by the tube failure detection circuit 34 is connected to the output side of the rectification circuit 40. Namely, the protection circuit 41 comprises the shutdown execution unit 42 and the shutdown stop unit 44, wherein the shutdown execution part 42 forces the lighting operation by the lighting control circuit unit 4 to terminate, when the tube failure detection circuit 34 detects the malfunction of the fluorescent lamp 1, and wherein the shutdown stop unit 44 stops the shutdown function of the oscillating circuit 17 temporarily at the time of filament preheating at the time of shutdown.

The shutdown execution unit 42 compares the partial voltage Vbb and the threshold value after rectification. If the partial voltage Vbb becomes equal to the threshold value or less, the shutdown execution part 42 will determine that the malfunction occurred in the fluorescent lamp 1, and will output the shutdown demand Ksd to the oscillating circuit 17. Thereby, no matter how the reference voltage Vk from the input circuit unit 3 is, the oscillating circuit 17 which received the shutdown demand Ksd stops oscillation operation, and forces lighting operation of the fluorescent lamp 1 to terminate.

On the other hand, the shutdown stop unit 44 keeps the shutdown function of the oscillating circuit 17 from operating during the preheating. The shutdown stop unit 44 outputs the stop demand Kit to the oscillation change circuit 43 over time to be decided by the damping time constant of RC circuit which consists of resistance and a capacitor. The oscillation change circuit 43 does not make the oscillating circuit 17 perform a shutdown, but performs oscillation operation on high frequency, while the shutdown stop demand Kit is inputted.

The preheating time of the fluorescent lamp 1 is the same value as the predetermined preheating time set up by the preheating time setting circuit 73 of the preheating control circuit unit, and is set up in the shutdown stop unit 44. Therefore, the preheating completion signal notifying the completion of the preheating time can be constituted to be acquired from the preheating time setting circuit 73 of the preheating control circuit unit (described later). Since RC damping time constant circuit which generates preheating time in the shutdown stop unit 44 is omissible, circuit composition can be made simple.

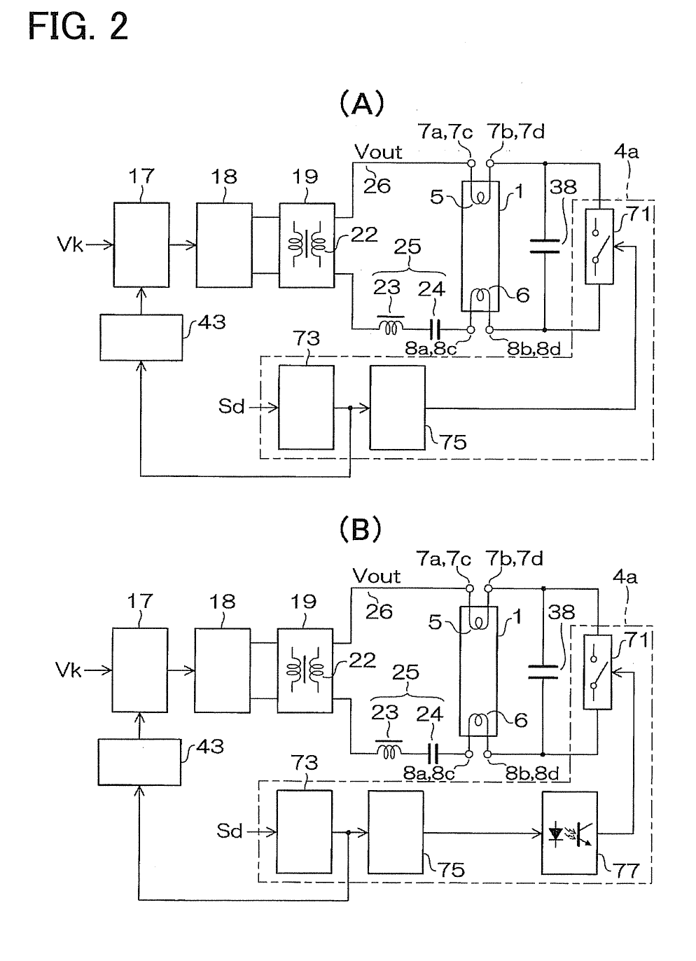

Thus, although the fluorescent lamp drive 2 comprises the protection circuit 2a which has an overheat protection function, the filament-snap detecting function, and the tube breakage detection function, the fluorescent lamp drive 2 of the present embodiment comprises a preheating control circuit unit 4a (refer to FIG. 2), which is in comparatively simple configuration.

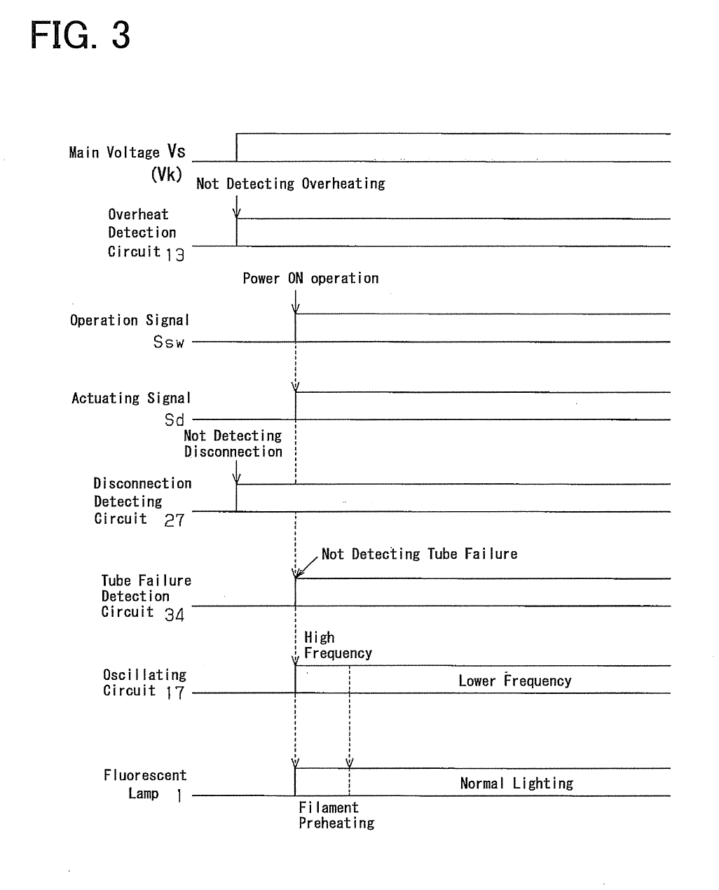

Next, operation of the fluorescent lamp drive 2 of this embodiment is described according to the FIG. 3 through FIG. 5.

As shown in FIG. 3, the case where disconnection has not occurred in the fluorescent lamp 1 is assumed. As for the power supply voltage Vcc, The noise will be removed by the noise filter 11 if the power supply voltage Vcc is inputted into the input terminal 9. The power supply voltage Vcc after noise reduction is outputted to the power supply circuit 12 for operation. The power supply circuit 12 outputs power supply voltage Vcc as the main voltage Vs, to the lighting control circuit unit 4. If the main voltage Vs is inputted into the lighting control circuit unit 4, the main voltage Vs will be impressed to the fluorescent lamp 1. Since the case where disconnection has not occurred in the fluorescent lamp 1 is assumed here, the disconnection detecting circuit 27 outputs the detection signal Sds of a normal value to the disconnection monitoring unit 33. Therefore, the disconnection monitoring unit 33 recognizes that the disconnection has not occurred in the fluorescent lamp 1 by receiving the normal detection signal Sds.

Moreover, with supply operation of the principal voltage Vs to the lighting control circuit unit 4, the power supply circuit 12 of operation lowers the power supply voltage Vcc after noise reduction and generates the reference voltage Vk, and outputs the reference voltage to the switch circuit 16 as a power supply of the oscillating circuit 17 of operation.

Temporarily, suppose that the ON operation of the power switch was carried out under this state. If the ON operation of a power switch is checked in the manual operation detector circuit 10, the signal output circuit 15 will output an ON signal to the switch circuit 16 as the actuating signal Sd, on condition that the overheating detection circuit 13 has not detected overheating. Since the overheating notification unit 14 takes lighting operation at this time, a user is notified of the fluorescent lamp 1 not being overheated.

If an ON signal is inputted as the actuating signal Sd from the signal output circuit 15, the switch circuit 16 will output the reference voltage Vk obtained from the power supply circuit 12 of operation to the oscillating circuit 17, on condition that the disconnection detecting circuit 27 has not detected disconnection. Thereby, the power is supplied to the oscillating circuit 17. If the reference voltage Vk is inputted from the switch circuit 16, the oscillating circuit 17 oscillates with the power of the voltage Vk. Then the high frequency alternating current voltage Vout is outputted from the secondary winding 22 of the transformer 19 through the inverter circuit 18. The fluorescent lamp 1 starts lighting operation by preheating the filament.

In order to make the fluorescent lamp 1 turn on with preheating current at this time, the oscillation change circuit 43 makes the oscillating circuit 17 oscillated on high frequency. By the way, since the tube voltage of the fluorescent lamp 1 becomes an unstable state when the fluorescent lamp 1 carries out filament preheating, the partial voltage Vbb of the tube failure detection circuit 34 may be less than a threshold value occasionally, and it is also assumed that the shutdown execution unit 42 of the protection circuit 41 functions. Therefore, in order to suspend a shutdown function at the time of filament preheating, the shutdown stop unit 44 outputs the shutdown stop demand Kit to the oscillation change circuit 43 for the time according to the CR constant. The oscillation change circuit 43 make the oscillating circuit 17 oscillated on high frequency during a preheating period, preventing it from shutdown.

After preheating time passes, the shutdown stop unit 44 suspends the output of the shutdown stop demand Kit. The shutdown stop demand Kit is no longer inputted into the oscillation change circuit 43, and the oscillation change circuit 43 oscillates the oscillating circuit 17 on low frequency. The secondary winding 22 of the transformer 19 outputs the high frequency alternating current voltage Vout which applied to low frequency correspondingly. The lighting operation of the fluorescent lamp 1 is switched to normal lighting from filament preheating.

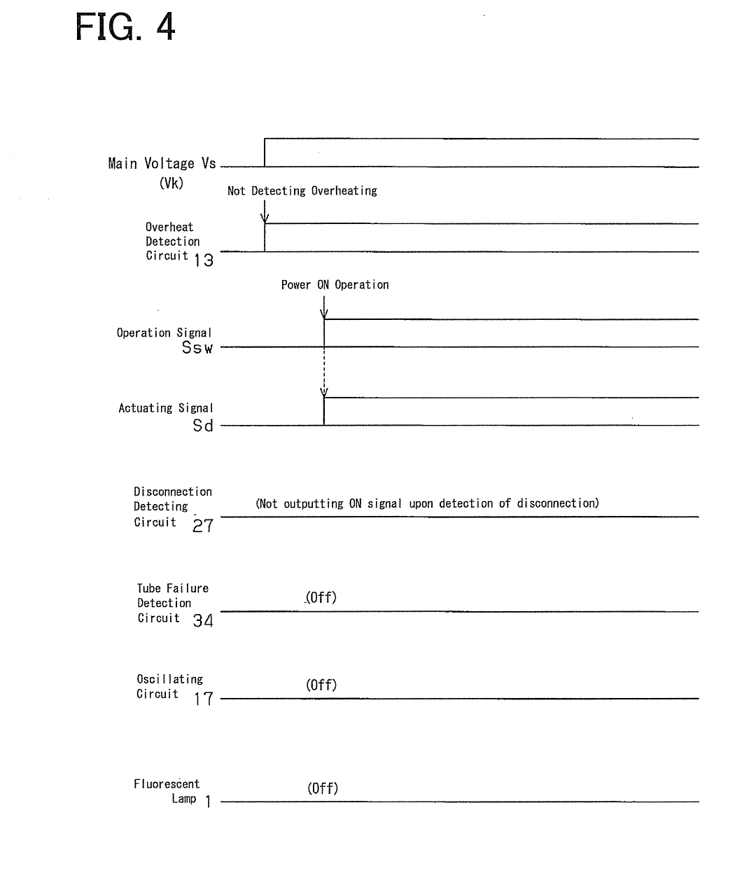

As shown in FIG. 4, the current does not flow into the current loop circuit 26 of the fluorescent lamp 1 even if the principal voltage Vs is impressed to the fluorescent lamp 1, when disconnection has occurred in the fluorescent lamp 1. Therefore, the disconnection detecting circuit 27 cannot output an ON signal under such conditions. Therefore, even if ON operation of the power switch is carried out and an ON signal is inputted into the switch circuit 16 from the signal output circuit 15, the switch circuit 16 does not respond to the signal. Since the reference voltage Vk is not supplied to the oscillating circuit 17, the lighting control circuit unit 4 does not operate, and the fluorescent lamp 1 maintains a putting-out-lights state.

When the malfunction has occurred in the tube of the fluorescent lamp 1, the partial voltage Vbb of the tube failure detection circuit 34 falls below in the threshold value, since the voltage between terminals of the filaments 5 and 6 becomes low. Therefore, the shutdown execution unit 42 checks that the partial voltage Vbb becomes below in a threshold value, and it recognizes that the malfunction in the tube have occurred in the fluorescent lamp 1, and outputs the shutdown demand Ksd to the oscillating circuit 17. The oscillating circuit 17 operates according to the shutdown demand Ksd, and forces lighting operation of the fluorescent lamp 1 to terminate.

In this embodiment, the capacitor 24 for direct-current component interception is formed in the closed current loop circuit 26 of the fluorescent lamp 1, and a direct-current component is cut from the current which flows into the current loop circuit 26 at the time of lighting of the fluorescent lamp 1. The disconnection detecting circuit 27 detects whether disconnection has occurred in the current loop circuit 26 which is the current course in the fluorescent lamp 1, and through which a direct-current component does not flow. Thus, the direct current is not sent through the secondary side of the transformer 19 for detection of filament malfunction. It enables to detect the disconnection without magnetic bias in the secondary side of the transformer 19. This embodiment makes the fluorescent lamp 1 turn on efficiently while having the function to detect disconnection of the fluorescent lamp 1.

Moreover, the fluorescent lamp drive 2 comprises the tube failure detection circuit 34 for monitoring the tube voltage that is the voltage between terminals between the filaments 5 and 6. And the fluorescent lamp drive 2 detects the malfunction in the tube with the partial voltage Vbb in the tube failure detection circuit 34. When filament disconnection or tube breakage occurs, there is a tendency of the partial voltage Vbb to rise. A filament disconnection and tube breakage can be detected by the tube failure detection circuit 34 disposed in the lighting control circuit unit 4, for the rise of the partial voltage Vbb is monitored.

According to the present embodiment, the following benefits can be acquired.

(1) The capacitor 24 for direct-current component interception is connected to the current loop circuit 26 connected with the fluorescent lamp 1. The disconnection in the loop circuit 26 is monitored by the disconnection detecting circuit 27 connected with the loop circuit 26. This embodiment makes the fluorescent lamp 1 turn on efficiently while having the function to detect disconnection of the fluorescent lamp 1.

(2) Since the tube failure detection circuit 34 which monitors the malfunction in the tube is formed between a pair of filaments 5 and 6 of the fluorescent lamp 1, such problems like tube breakage or the filament disconnection in the fluorescent lamp 1 are detectable. And the fluorescent lamp drive 2 can be switched to halt in the abnormal condition, since forced outage of the operation of the fluorescent lamp drive 2 is carried out when a filament disconnection or tube breakage occur in the fluorescent lamp 1.

(3) The tube failure detection circuit 34 comprises two or more resistance 35 through 37. The detection level of the tube failure detection circuit 34 can be easily changed by changing the resistance of the resistance 35 through 37, or adding extra resistance, when change of a detection level is necessary for according to the type of fluorescent lamp 1.

(4) Since the input circuit unit 3 comprises the overheating detection circuit 13, lighting of the fluorescent lamp 1 by the fluorescent lamp drive 2 is forced to terminate, when fluorescent lamp drive 2 or fluorescent lamp 1 itself is overheated. Therefore, the fluorescent lamp drive 2 and the fluorescent lamp 1 can be protected from overheating.

(5) The switch circuit 16, the oscillating circuit 17 and the protection circuit 41, and oscillation change circuit 43 which mainly control the turning on and off of the fluorescent lamp 1 consist of analog circuitry where the output level changes continuously according to the change of the continuous input. Therefore, the circuit for controlling turning on and off in the fluorescent lamp drive 2 can be simple analog circuitry.

### The Second Embodiment

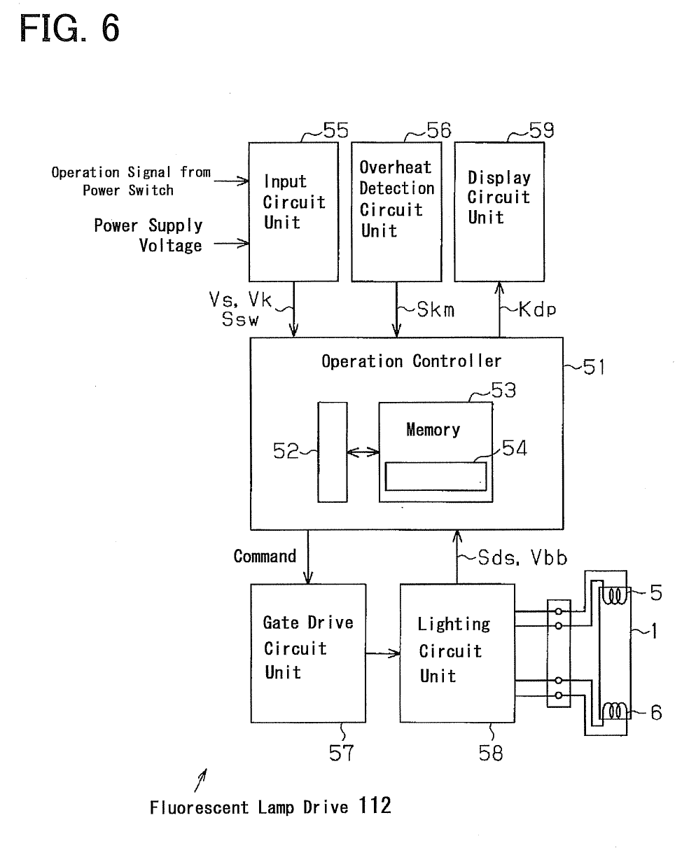

Next, the second embodiment of the present invention is explained according to FIG. 6. This embodiment differs to the first embodiment in controlling turning on and off of the fluorescent lamp 1 by software circuitry. So the same number is given to the equivalent elements as the first embodiment, and the details are omitted and only different elements are described fully.

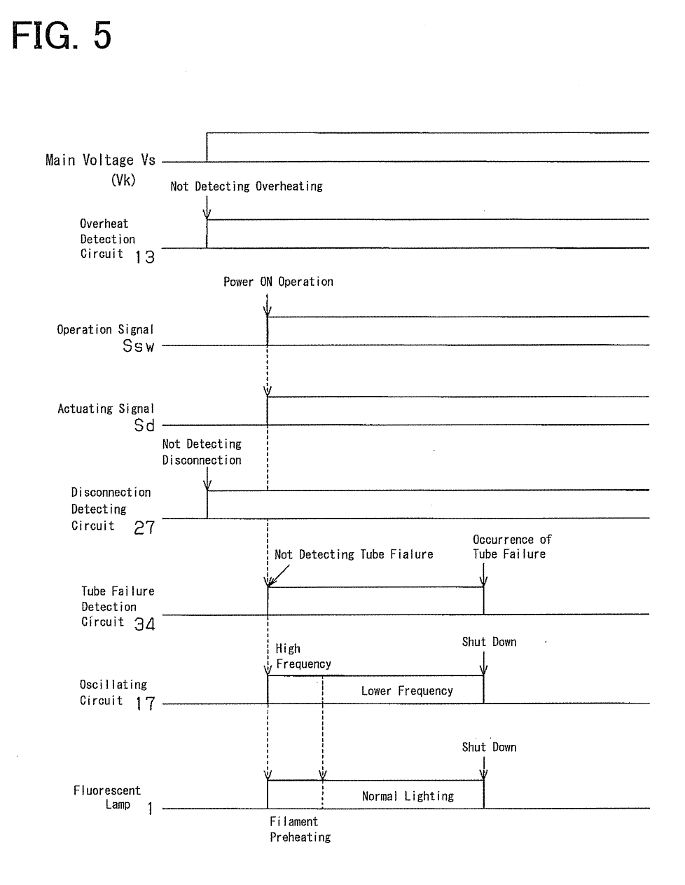

As shown in FIG. 5, the operation controller 51 which controls programmably turning on and off of the fluorescent lamp 1 is provided in the fluorescent lamp drive 112. The operation controller 51 employs a software circuit comprising CPU (Central Processing Unit) 52 and memory 53, and performs lighting and turning off operation according to the control program 54 stored in the memory 53. Moreover, the operation controller 51 consists of a control IC (Integrated Circuit) formed into one chip. The operation controller 51 of this embodiment is a circuit which works equivalently to the elements such as the switch circuit 16, the oscillating circuit 17, the protection circuit 41, and the oscillation change circuit 43 of the first embodiment. The operation controller 51 constitutes the lighting controller of the present invention, and the control program 54 is equivalent to the program of the present invention.

The input circuit unit 55 which inputs the power supply voltage Vcc and the operation signal Ssw, and the overheat detection circuit unit 56 which detects the overheat of the fluorescent lamp 1 are connected to the operation controller 51. The input circuit unit 55 notifies the operation controller 51 that the operation signal Ssw has been inputted while carrying out the conversion of the inputted power supply voltage Vcc to the main voltage Vs and the reference voltage Vk. The overheat detection circuit unit 56 monitors overheating of the fluorescent lamp 1 by detecting generation of heat in the input circuit unit 55, and outputs the overheat notice Skm based on the detection result to the operation controller 51. The overheat detection circuit unit 56 constitutes the overheat detector of the present invention.

The lighting circuit unit 58 is connected to the operation controller 51 via the gate drive circuit unit 57 which works as a drive circuit. The lighting circuit unit 58 of this embodiment is a circuit equivalent to the combination of the inverter circuit 18, the transformer 19, the disconnection detecting circuit 27, the tube failure detection circuit 34, the filter circuit 39, and the rectification circuit 40 of the first embodiment. The lighting circuit unit 58 changes the direct-current voltage inputted from the operation controller 51 into the high frequency alternating current voltage Vout by the inverter circuit 18 and the transformer 19. The lighting circuit unit 58 outputs voltage Vout to the fluorescent lamp 1, and makes the fluorescent lamp 1 turn on. The lighting circuit unit 58 outputs the detection signal Sds of the disconnection detecting circuit 27 and the partial voltage Vbb of the tube failure detection circuit 34 to the operation controller 51.

The operation controller 51 comprises the display circuit unit 59 which displays the operating state of the fluorescent lamp drive 112. When the operation controller 51 detects disconnection of the fluorescent lamp 1 by the disconnection detecting circuit 27, the abnormalities in a tube by the tube failure detection circuit 34, or overheating by the overheat detection circuit unit 56, the operation controller 51 stops the operation of the fluorescent lamp drive 112 and outputs the display demand Kdp to the display circuit unit 59. If this display demand Kdp is inputted, the display circuit unit 59 will switch off the LED, and will notify the user of the abnormalities.

Now, in this embodiment, the operation controller 51 which has software circuitry carries out the control of the fluorescent lamp 1. To switch the pattern of the fluorescent lamp 1 of operation, it only requires changing the control program 54 stored in the memory 53 of the operation controller 51. Therefore, since the operation pattern of the fluorescent lamp 1 can be changed by only rewriting of program, the work for changing the operation pattern becomes easy.

According to this embodiment, in addition to the benefit (1) through (5) of the first embodiment, the benefit described below can be acquired.

(6) The circuit which mainly manages control of the fluorescent lamp 1 is the operation controller 51 which is a software circuit. Changing the operation of the fluorescent lamp 1 only requires changing the control program 54 stored in the memory 53 of the operation controller 51 into other programs. Thus, the operation pattern of the fluorescent lamp 1 can be changed without changing the hardware of the fluorescent lamp drive 112.

### The Third Embodiment

Next, the third embodiment is described, referring to FIG. 1 and FIG. 2 that extracted the component part about preheating control from the diagram in FIG. 1. In the fluorescent lamp drive 112, the fluorescent lamp 1, the input circuit unit 3, and the lighting control circuit unit 4 are the same as that of the first embodiment. The equivalent features are given the same mark as the corresponding elements in the first embodiment, and only the different features are explained in full detail.

Preheating Control Circuit Unit 4a

As shown in FIG. 2 (A), the preheating control circuit unit 4a comprises a switch 71, a preheating time setting circuit 73, and a switch drive circuit 75. The switch 71 is an analog switch which consists of switching elements, such as MOSFET, and it carries out on-off control according to the gate control signal inputted into a gate terminal.

As long as it can output and input bidirectionally and is constituted by the semiconductor, the analog switch may be a unipolar transistor, such as CMOS, or a bipolar transistor. However, since it is necessary to preheat the filaments (the first filament 5 and the second filament 6) of the fluorescent lamp 1, it requires the capacity that the maximum allowed voltage is more than 400V, and that the maximum allowed current is more than 1.5 A.

SSR (solid state relay) and a mechanical relay may go up as examples of the switch 71. However, generally speaking, the higher the maximum allowed voltage of SSR is, the smaller the maximum allowable current is, and the larger the maximum allowed current is, the lower the maximum allowable voltage is. Therefore, SSR is unsuitable for the switch 71, for its balance of the maximum allowed voltage and the maximum allowed current hardly matches to the requirement.

A mechanical relay and switch have very slow switching speed compared with a semiconductor switch, and tend to generate the noise and chattering by arc discharge. Furthermore, a mechanical relay and switch tend to cause enlargement of the fluorescent lamp drive. Therefore, it is hard to consider adopting a mechanical relay and switch as the switch 71. In the fluorescent lamp drive 112 applied to this embodiment, the switch 71 is adopted as the analog switch for the reason mentioned above.

Since the switching time of an analog switch is on the level of 100 ns, it takes within 1 ms or less to operate, even if a photocoupler 77 is disposed before the switch 71 as shown in FIG. 2 (B). On the other hand, the switching speed of a mechanical relay is on the level of 10 mS, thus it is 100 times or more as slow as an analog switch.

An example of the maximum allowed voltage and the maximum allowed current of SSR is shown below.

G3VM-61A1 (OMRON Corp.): Allowable voltage 60V, Allowable current 0.5AG3VM-202J1 (OMRON Corp.): Allowable voltage 200V, Allowable current 0.2AG3VM-351G (OMRON Corp.): Allowable voltage 350V, Allowable current 0.11 A.

The preheating time setting circuit 73 sets up the preheating time of the fluorescent lamp 1. In this embodiment, the actuating signal Sd outputted from the input circuit unit 3 acts as a lighting demand (ON signal), and the preheating time of the fluorescent lamp 1 is set up with a predetermined value (for example, 0.4-3.0 seconds). The preheating time setting circuit 73 makes the first filament 5 and the second filament 6 of the fluorescent lamp 1 preheat over the time (T=R×C) according to the time constant of the RC circuit which consists of resistance and a capacitor. The preheating time setting circuit 73 outputs the control signal in an H level to the switch drive circuit 75 and the oscillation change circuit 43 during the preheating time.

Since the oscillating circuit 17 is oscillated on high frequency (for example, about 100 kHz) during a preheating time, The preheating time setting circuit 73 outputs a control signal to the oscillation change circuit 43, and is enabling a setup of the oscillating frequency of the oscillating circuit 17. The preheating time setting circuit 73 may be equivalent to the “frequency control circuit” of the present invention with the above-mentioned oscillation change circuit 43.

The predetermined preheating time set by the preheating time setting circuit 73 is the same as the preheating time of the fluorescent lamp 1 set by the shutdown stop unit 44. Therefore, the preheating time expiration signal, which tells the end of the preheating time, may be acquired from the shutdown stop unit 44. The preheating time setting circuit 73 can be simplified, since the RC time constant circuit which provides preheating time in the preheating time setting circuit 73 is omissible.

The switch drive circuit 75 carries out on-off control of the switch 71 and outputs a gate control signal to the switch 71 in response to the control signal from the preheating time setting circuit 73. In this embodiment, the switch drive circuit 75 turns ON the switch 71 in response to the control signal of H level, and in the case of others, switching control of the switch 71 is performed so that the switch 71 may be turned OFF. The control signal of H level is outputted from the preheating time setting circuit 73 during the preheating. The switch drive circuit 75 is equivalent to the “switch control circuit” of the present invention.

The switch 71 changes the both ends of the capacitor 38 into an electrical connection state during the preheating by the preheating control circuit unit 4a as mentioned above. It will be in a short circuit state between the contact buttons 7d and 8d by the side of the non-power supply of the filament (the first filament 5, the second filament 6) of the fluorescent lamp 1, irrespective of the capacitor 38. Thereby, between the power supply side contact buttons 7c and 8c can be changed into an electrical connection state in direct current via the non-power supply side contact buttons 7d and 8d of a short circuit state.

The control signal which oscillates the oscillating circuit 17 on high frequency (for example, about 100 kHz) during the preheating is transmitted to the oscillation change circuit 43 from the preheating time setting circuit 73. The high frequency voltage is outputted to the fluorescent lamp 1 from the first contact button 7a and the second contact button 8a. Thus, the filament of the fluorescent lamp 1 can generate heat and complete preheating in a short period of time.

As shown in FIG. 2 (B), the photocoupler 77 may be disposed between the gate terminal of the switch 71, and the output of the preheating time setting circuit 73. The gate voltage impressed to the gate terminal of the switch 71 is drived only on the output side of the photocoupler 77. The gate terminal can be electrically insulated to the current loop circuit 26 and its circumference circuit which supply the high frequency voltage Vout to the fluorescent lamp 1. The switch 71 is not easily influenced by the high frequency noise which occurs from current loop circuit 26, even if the input impedance of the gate terminal of the switch 71 is comparatively high. Therefore, malfunction of the switch 71 caused by a high frequency noise can be suppressed.

The malfunction can be controlled further by adding the capacitor and inductor for noise reduction to the input side of the photocoupler 77. Moreover, the on-off control of the switch 71 becomes quicker by connecting the bleeder resistance in parallel in the output side of the photocoupler 77.

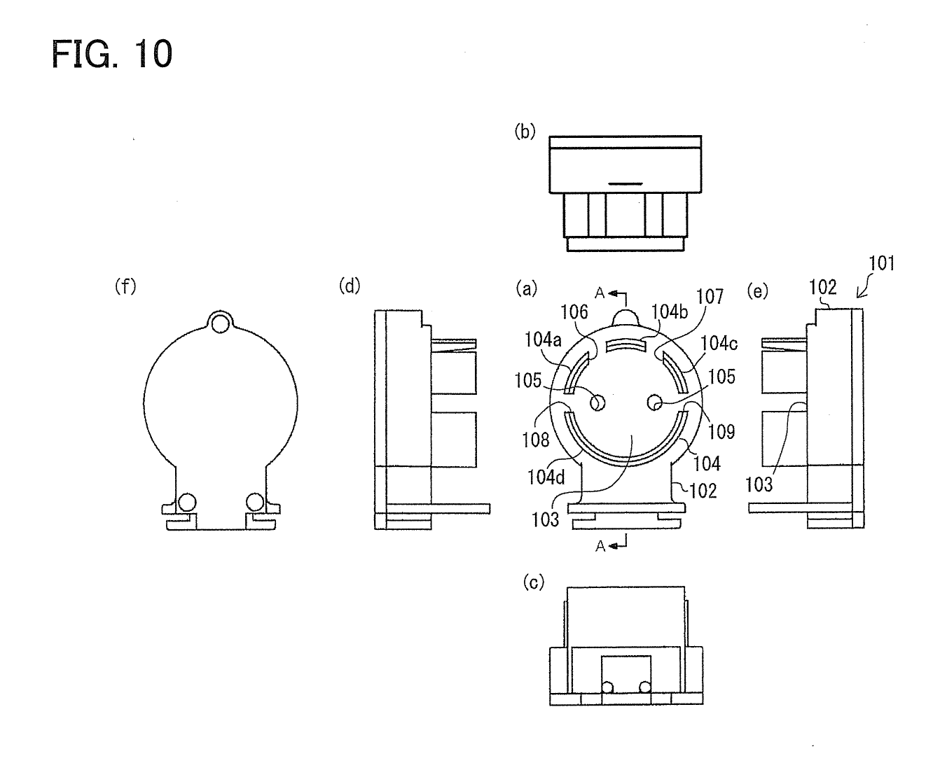

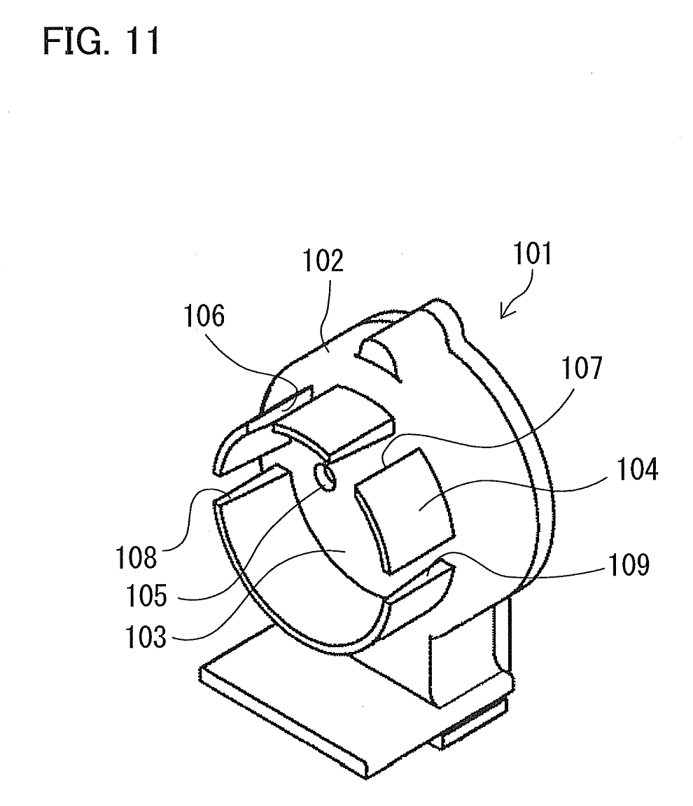

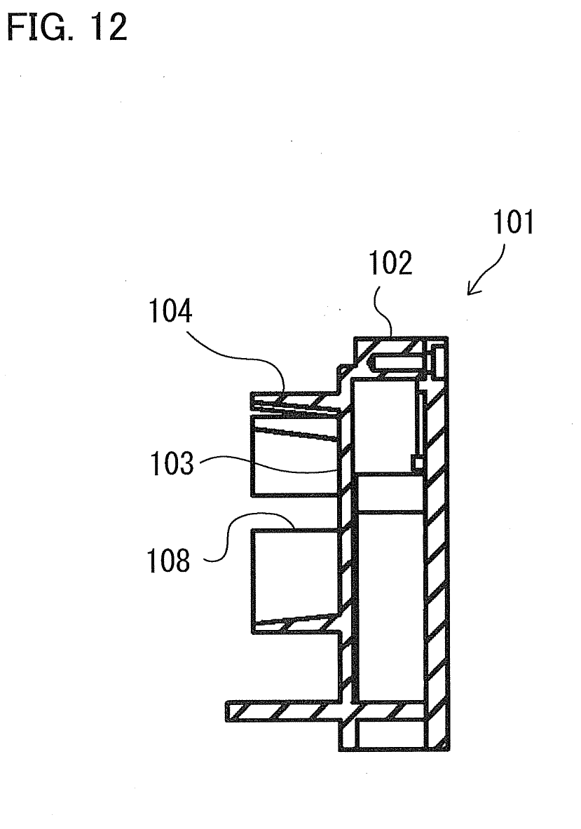

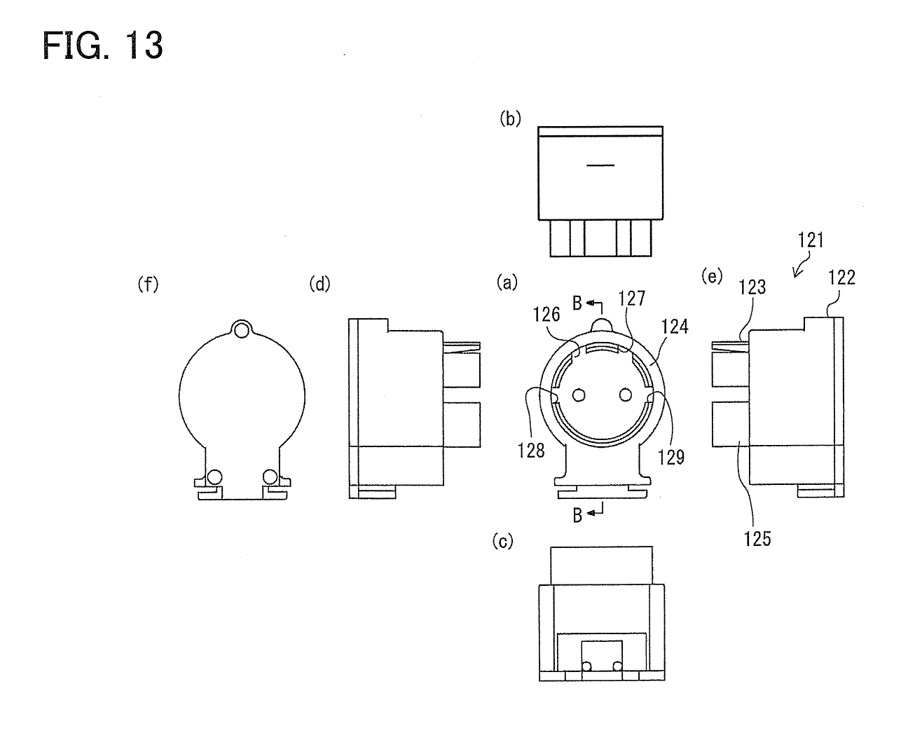

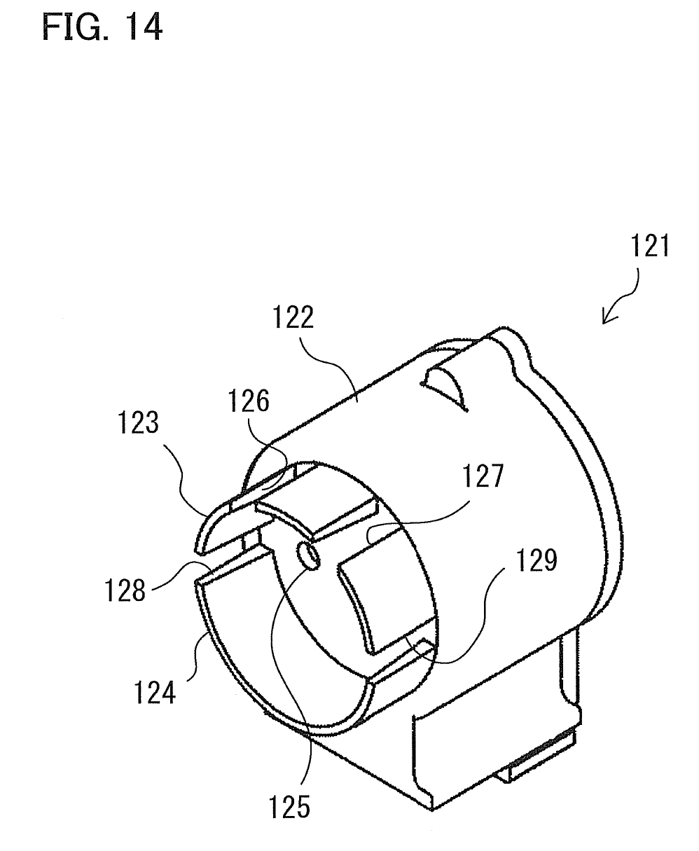

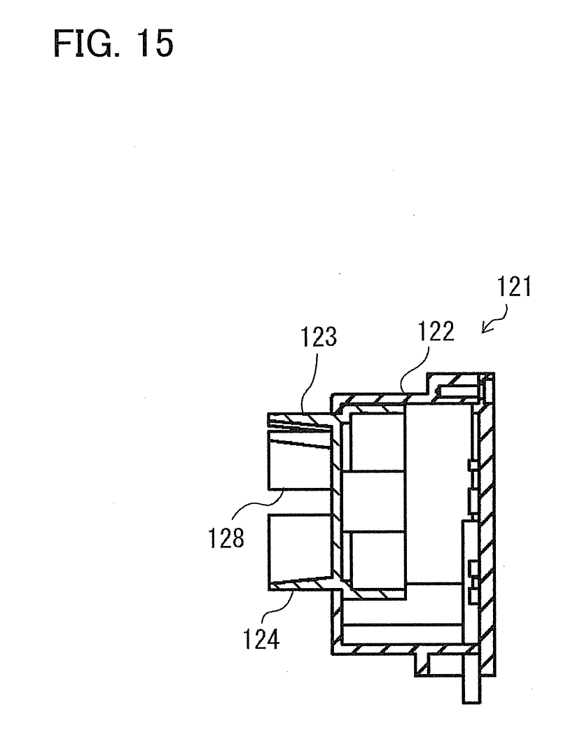

Next, the fluorescent lamp attachment 100 provided in the fluorescent lamp 1 is described. FIG. 10 is a combination of views of the first fluorescent lamp socket which constitutes the socket set for a fluorescent lamp. FIG. 11 is a perspective view of the first fluorescent lamp socket. FIG. 12 is a cross sectional view of the socket in FIG. 10 at the AA line. FIG. 13 is a combination of views of the second fluorescent lamp socket which constitutes the socket set for a fluorescent lamp. FIG. 14 is a perspective view of the second fluorescent lamp socket. FIG. 15 is a cross sectional view of the socket in FIG. 13 at the BB line.

The fluorescent lamp attachment 100 comprises a first fluorescent lamp socket 101 shown in FIG. 10 to FIG. 12 and a second fluorescent lamp socket 121 shown in FIG. 13 to FIG. 15 disposed oppositely. The connectors on both ends of the fluorescent lamp 1 which is a fluorescent lamp tube is attached to the first fluorescent lamp socket 101 and the second fluorescent lamp socket 121, respectively. As shown in the FIGS. 10 through 12, the fluorescent lamp supporter 104 of the first fluorescent lamp socket 101 is projected from the fluorescent lamp clamp face 103 of the socket main part 102. The fluorescent lamp supporter 104 is in a shape that meets along the perimeter side of the fluorescent lamp 1. The fluorescent lamp supporter 104 consists of four projecting protection pieces 104a through 104d. The slits 106, 107 is formed between the protection piece 104a and the protection piece 104b, and between the protection piece 104b and the protection piece 104c, respectively. The slits 108, 109 is formed between the protection piece 104a and the protection piece 104d. The slits 106, 107 is located right above the recess 105, and the slits 108, 109 is located horizontally just beside the recess 105. Each width of the slits 106 through 109 is wider than the thickness of the electrode terminal (not shown) of the fluorescent lamp 1.

As shown in FIGS. 13 through 15, the second fluorescent lamp socket 121 is constituted in a way that the fluorescent lamp movable supporter 123 is slidably attached to the socket holder 122, the movable supporter 123 is biased in the direction being pushed out from the socket holder 122 by means of a spring (not shown). Thereby, a fluorescent lamp supporter 125 can go in and out through an opening 124 of the socket holder 122. The slits 126 through 129 is formed in the fluorescent lamp supporter 125 as well as the slits 106 through 109 between the fluorescent lamp supporter 104.

Three round shapes which appears in the rear elevation of the third fluorescent lamp socket 101 and the second fluorescent lamp socket 121 is screw holes for the attachment to the main body.

Conventionally, the power supply terminal of the fluorescent lamp was inserted in the socket and supported the fluorescent lamp. Therefore, if the power supply terminal had not been firmly inserted in the socket, the fluorescent lamp might fall. If the support component which supports a fluorescent lamp is added in order to prevent such danger, structure will become complicated and cost will go up. If the supporter is added, it is necessary to detach and attach the supporter and/or to decompose a socket for attachment and detachment of the fluorescent lamp 1. Therefore, there was a problem of requiring more time for work, compared with the case where a fluorescent lamp is just inserted in the sockets.

On the other hand, in the fluorescent lamp attachment 100 of this embodiment, the fluorescent lamp supporter 125 is biased by means of a spring, and can be slid toward and against the socket holder 122. When detaching and attaching the fluorescent lamp 1, the fluorescent lamp supporter 125 of the second fluorescent lamp socket 121 is made to slide. it becomes easy to attach and detach the power supply terminal of the fluorescent lamp 1 to the first fluorescent lamp socket 101 and the second fluorescent lamp socket 121. A power supply terminal is easily taken in and out in the fluorescent lamp supporter 104 by letting the slits 106 through 109 pass for the power supply terminal by the side of the first fluorescent lamp socket 101. The fluorescent lamp 1 is easy to attach about the second fluorescent lamp socket 121 by letting the power supply terminal pass in the slits 126 through 129. Since it can let a power supply terminal pass from any direction of three directions through the slits 106 through 109, and 126 through 129, the direction the fluorescent lamp 1 is detached and attached can be chose, which makes workability good. If the fluorescent lamp 1 is attached, it is held so that the end of a fluorescent lamp may be surrounded by the fluorescent lamp supporter 104 and 125, and the fluorescent lamp 1 is supported, preventing fall of the fluorescent lamp.

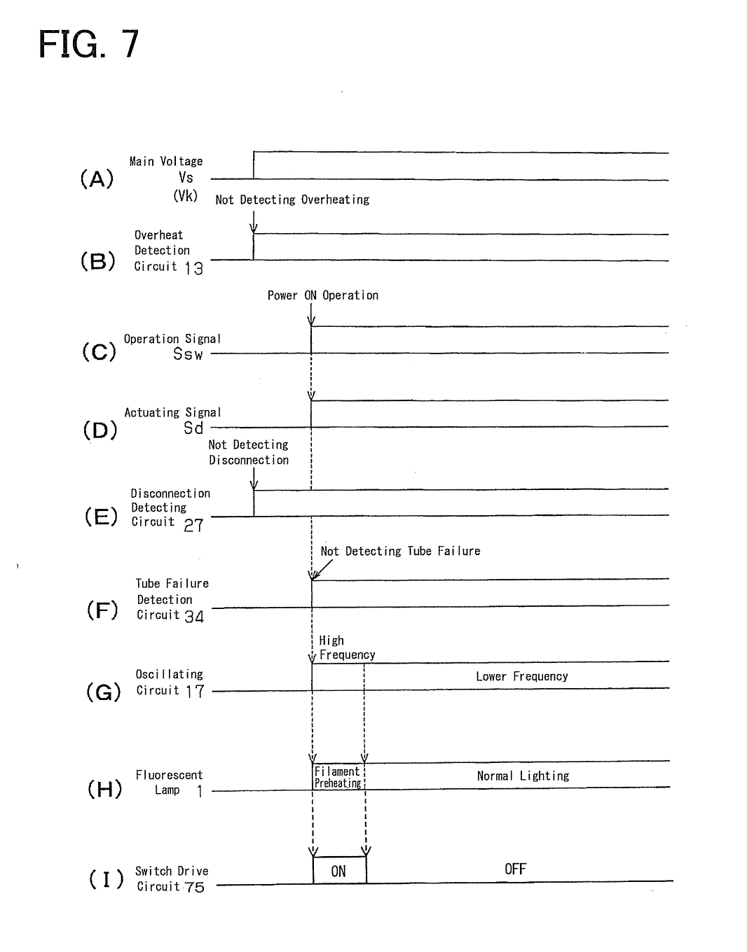

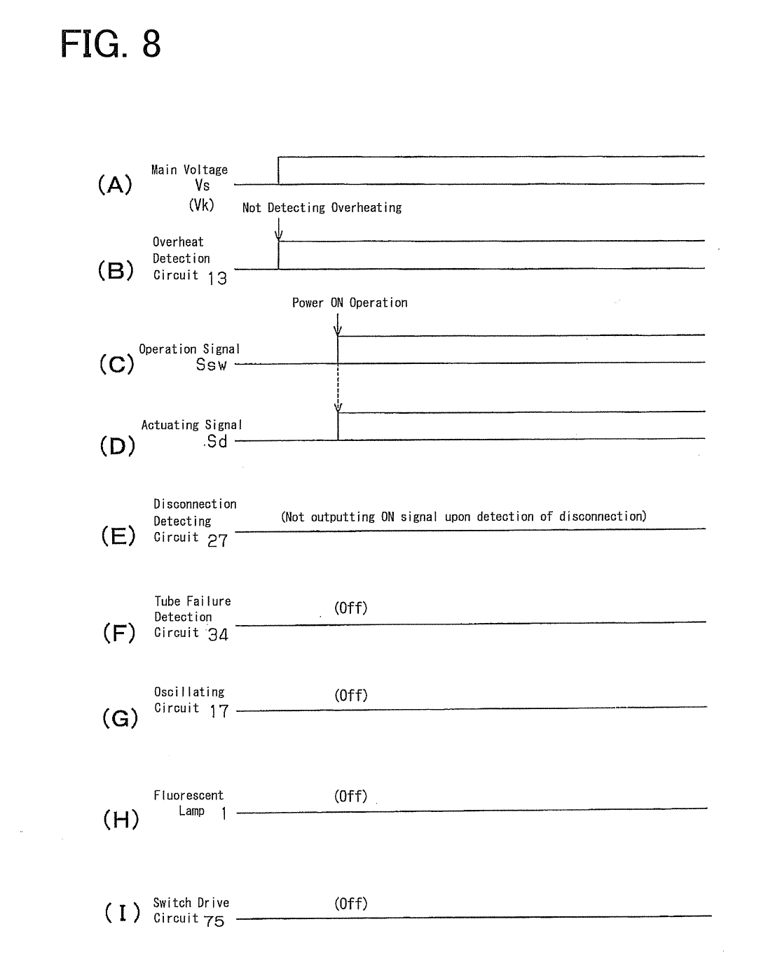

Next, operation of the fluorescent lamp drive 112 concerning the present embodiment is described referring to FIG. 7 and FIG. 8. First, with reference to FIG. 7, the case where abnormalities, such as disconnection, have not occurred in the fluorescent lamp 1 is described. Then, with reference to FIG. 8, the case where abnormalities have occurred in the fluorescent lamp 1 is described.

If the power supply voltage Vcc is supplied to the fluorescent lamp drive 112 from the outside, after noise reduction of the power supply voltage Vcc inputted from the input terminal 9 is carried out with the noise filter 11, it will be inputted into the power supply circuit 12. In the power supply circuit 12, while generating the principal voltage Vs based on the power supply voltage Vcc, and the reference voltage Vk is also generated by lowering the voltage. The voltage Vs and Vk(s) is outputted to the lighting control circuit unit 4, and the electric power is supplied to the lighting control circuit unit 4. The current by the principal voltage Vs flows into the filaments 5 and 6 of the fluorescent lamp 1 through the resistance 35 through 37 of the lighting control circuit unit 4. Thereby, the disconnection detecting circuit 27 becomes capable of the detection of wire disconnection (FIG. 7 (A)).

Overheating is also detected by the overheat detection circuit 13. When overheating of the fluorescent lamp 1 is not detected, the detection signal of H level is outputted and the overheating notification unit 14 lights up. And when overheating is detected, the detection signal of L level is outputted and the overheating notification unit 14 goes out. The detection signal of H level is outputted in the case overheating is not detected (FIG. 7 (B)).

Moreover, when disconnection has not occurred in the fluorescent lamp 1, the detection signal Sds of a normal value is outputted from the disconnection detecting circuit 27 to the disconnection monitoring unit 33. The disconnection monitoring unit 33 which received this signal judges that disconnection has not occurred in the fluorescent lamp 1 (FIG. 7 (E)).

If a power switch is operated by ON, the manipulate signal Ssw of an ON state will be detected, by the manual operation detector circuit 10 (FIG. 7 (C)). The signal output circuit 15 outputs an ON signal to the switch circuit 16 and the preheating time setting circuit 73 as the actuating signal Sd, when there is no overheating detection by the overheating detection circuit 13 (FIG. 7 (D)).

If the ON signal is inputted as the actuating signal Sd from the signal output circuit 15, the switch circuit 16 will output the reference voltage Vk obtained from the power supply circuit 12 to the oscillating circuit 17, on condition that the disconnection detecting circuit 27 has not detected disconnection. The ON signal as this actuating signal Sd is inputted also into the preheating time setting circuit 73. If this ON signal is received, the preheating time setting circuit 73 will start predetermined preheating time. The preheating time setting circuit 73 outputs a control signal to the oscillation change circuit 43, and makes the oscillation change circuit 43 change the oscillating frequency of the oscillating circuit 17 to a high frequency (for example, about 100 kHz). Thereby, if the oscillating circuit 17 starts an oscillation on high frequency (FIG. 7 (G)) and the switching element of the inverter circuit 18 is turned on/turned off alternately, the high frequency voltage Vout will be outputted from the secondary winding 22 of the transformer 19.

If predetermined preheating time starts, the preheating time setting circuit 73 outputs a control signal to the switch drive circuit 75 during the preheating concerned (FIG. 7 (1)), in order to make the switch drive circuit 75 outputs the gate control signal (for example, H level) to the switch 71 to turn on the switch 71.

The switch 71 is controlled to the ON state from an OFF state. The high frequency voltage Vout outputted from the secondary winding 22 of the transformer 19 is impressed to the filament (the first filament 5 and the second filament 6) of the fluorescent lamp 1. The switch 71 being in the ON state, the high frequency voltage Vout flows through the bidirectional electricity route comprising the first contact button 7a of one side, the power supply side contact button 7c, the first filament 5, the non-power supply side contact button 7c1, the first contact button 7b of the other side, the switch 71, the second contact button 8b of the other side, the non-power supply side contact button 8d, the second filament 6, the power supply side contact button 8c, and the second contact button 8a of one side, and preheating of a filament is attained (FIG. 7 (H)).

In the case of filament preheating, the switch 71 will be in an ON state. Therefore, the partial voltage by the resistance 35 through 37 which constitutes the tube failure detection circuit 34 does not occur. The partial voltage Vbb outputted from the tube failure detection circuit 34 is set to 0V. Although abnormalities have not occurred in the tube, the shutdown execution unit 42 may operate. The shutdown stop demand Kit is outputted to the oscillation change circuit 43 for a predetermined time which is decided by the damping time constant of RC circuit mentioned above so that this function may not work. The oscillation change circuit 43 keeps the oscillating circuit 17 from shutting down and oscillates the oscillating circuit 17 on high frequency during the preheating by the operation.

If the preheating period passes, the preheating time setting circuit 73 will output a control signal to the switch drive circuit 75. The switch drive circuit 75 outputs the gate control signal (for example, L level) to the switch 71, which turns OFF the switch 71. At the same time of this operation, the preheating time setting circuit 73 outputs a control signal to the oscillation change circuit 43, and the oscillation change circuit 43 switches the oscillating frequency of the oscillating circuit 17 to low frequency (for example, about 40 kHz). Thereby, the oscillating circuit 17 starts an oscillation on low frequency (FIG. 7 (G)). Since the switch 71 will be switched to the OFF state (FIG. 7 (1)), it shifts to the normal lighting control. Lighting operation of the fluorescent lamp 1 is switched to the normal lighting from the filament preheating (FIG. 7 (H)). This is the same as that of the case where there is no switch 71.

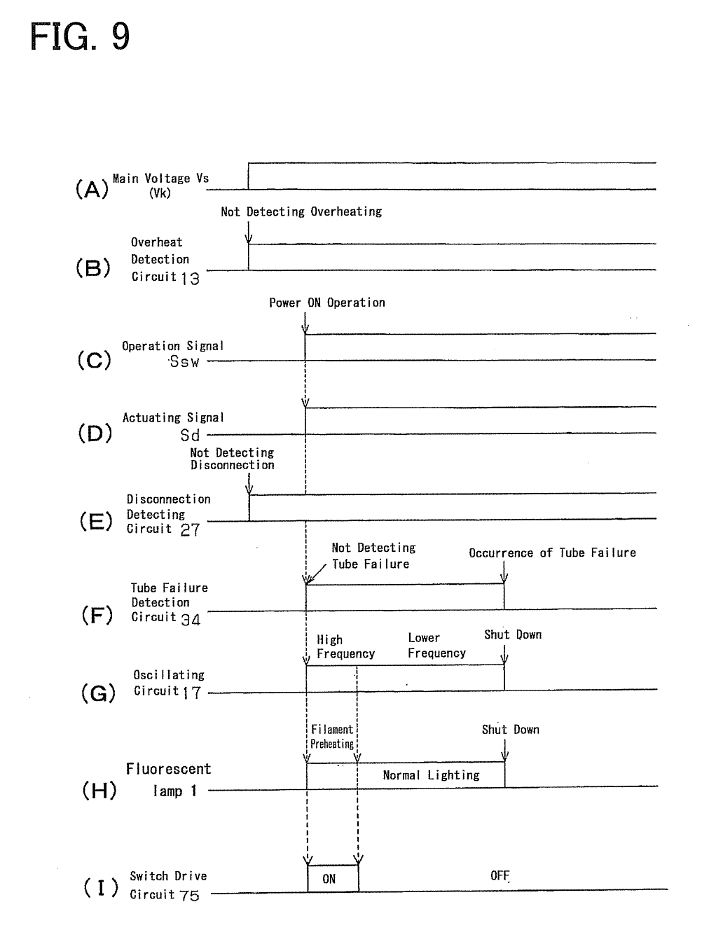

Then, the case where abnormalities have occurred in the fluorescent lamp 1 is described with reference to FIG. 8 and FIG. 9.

First, the case where the filament of the fluorescent lamp 1 is disconnected is described.

When the filament is disconnected as shown in FIG. 8, even if the power supply circuit 12 generates the principal voltage Vs and the voltage is impressed to the fluorescent lamp 1 based on the power supply voltage Vcc after noise rejection, the current does not flow into the current loop circuit 26 of the fluorescent lamp 1.

The disconnection detecting circuit 27 cannot output an ON signal (FIG. 8 (E)). If ON operation of the power switch is carried out and an ON signal is inputted into the switch circuit 16 from the signal output circuit 15 (FIG. 8 (D)), the switch circuit 16 does not answer this. Therefore, the fluorescent lamp 1 maintains the putting-out state, without the lighting control circuit unit 4 operating, since the reference voltage Vk is not supplied to the oscillating circuit 17 (FIG. 8 (F), (G), (I)) (FIG. 8 (H)).

Next, the case where an abnormality in the tube has occurred in the fluorescent lamp 1 is described.

As shown in FIG. 5, when an abnormality in the tube has occurred, the voltage between terminals of the first filament 5 and the second filament 6 becomes low. Therefore, the partial voltage Vbb of the tube failure detection circuit 34 falls to less than a threshold value (FIG. 9 (F)).

If the partial voltage Vbb which fell to less than the threshold value is inputted, the shutdown execution unit 42 will detect that the partial voltage Vbb is less than a threshold value, determine that an abnormality in the tube occurred in the fluorescent lamp 1, and output the shutdown demand Ksd to the oscillating circuit 17 (FIG. 9 (G)). Thereby, the oscillating circuit 17 operates according to the shutdown demand Ksd, and forces lighting operation of the fluorescent lamp 1 to terminate (FIG. 9 (H)). When the abnormalities in the tube have occurred in the fluorescent lamp 1, the fluorescent lamp 1 becomes the same state about operation of the switch drive circuit 75 at the beginning as under the normal situation shown in FIG. 7, since the light is being switched on normally.

The fluorescent lamp drive 112 of the present embodiment, in addition to the fluorescent lamp drive 2 that changes the direct-current voltage Vcc into the high frequency voltage Vout by the inverter circuit 18, and makes the fluorescent lamp 1 turn on with the high frequency voltage Vout, comprises: a series resonance circuit that is constituted including the secondary winding 22 of the transformer 19, the choke coil 23, and the capacitor 24 for direct-current interception, the transformer 19 being connected in series between each power supply side contact buttons 7c and 8c of the first filament 5 and the second filament 6 constituting the fluorescent lamp 1, wherein the series resonance circuit supplies the resonance frequency at the time of lighting of the fluorescent lamp 1; the capacitor 38 that is connected among the non-power supply side contact buttons 7d and 8d of the first filament 5 and the second filament 6; the switch 71 that is connected in parallel with the capacitor 38; and the switch drive circuit 75 that is constituted so that on-off control of the switch 71 is possible, wherein the switch 71 is turned ON during the preheating period before lighting of the fluorescent lamp 1, and is turned OFF after a preheating period.

The capacitor 38 is connected between the non-power supply side contact buttons 7d and 8d of the first filament 5 and the second filament 6. The switch 71 is set to ON during the preheating. It will be in a short circuit state with the switch 71 between the non-power supply side contact buttons 7d and 8d. A pair of first filaments 5 and the second filament 6 which constitute the fluorescent lamp 1 can change the power supply side contact buttons 7c and 8c into an electrical connection state in direct current via the non-power supply side contact buttons 7d and 8d in a short circuit state. The fluorescent lamp drive 112 comprises the secondary winding 22, the choke coil 23, the capacitor 24 for direct-current interception, the capacitor 38, the switch 71, and the switch drive circuit 75 of the transformer 19, and is comparatively simple composition. The transformer 19 constitutes a series resonance circuit required for the usual lighting control. The capacitor 38 is connected between the non-power supply side contact buttons 7d and 8d of the first filament 5 and the second filament 6. The switch drive circuit 75 carries out on-off control of the switch 71. Since the fluorescent lamp 1 does not turn it on even if it impresses the high frequency voltage Vout to the first filament 5 and the second filament 6 during a preheating period, the fluorescent lamp drive 112 can preheat the first filament 5 and the second filament 6 without making the fluorescent lamp 1 turn on before the end of preheating.

The fluorescent lamp drive 2 is equipped with the switch 71 and the switch drive circuit 75 which carries out on-off control of it, and although it is comparatively simple composition, it performs proper preheating.

The fluorescent lamp drive 112 of this embodiment is equipped with the oscillation change circuit 43 and the preheating time setting circuit 73 which control the frequency of the high frequency voltage Vout. The oscillation change circuit 43 and the preheating time setting circuit 73 set the frequency of the high frequency voltage Vout in the preheating period as about 100 kHz, which is higher than the frequency (for example, about 40 kHz) after the preheating period. The first filament 5 and the second filament 6 will be in an electrically connected state by direct current during the preheating. And the high frequency voltage Vout at 100 kHz is impressed to the first filament 5 and the second filament 6. Thereby, preheating of the fluorescent lamp 1 is performed within a short period of time. In the present embodiment, the high frequency voltage Vout is usually set about 100 kHz during the preheating period, and about 40 kHz during the normal lighting period, respectively. However, the frequency of the high frequency voltage Vout in the preheating period should be within a frequency band which can overheat the first filament 5 and the second filament 6. Therefore, the frequency of the high frequency voltage Vout may be 200 kHz, 400 kHz, 800 kHz, 1 MHz, or even higher frequencies.

Furthermore, according to the fluorescent lamp drive 2 concerning this embodiment, the gate terminal of the switch 71 is electrically insulated by the photocoupler 77 to the current loop circuit 26 and its circumference circuit of the fluorescent lamp 1, with which the high frequency voltage Vout is supplied. Thereby, it is not easily influenced by the high frequency noise from the current loop circuit 26 of the fluorescent lamp 1 when the input impedance of the gate terminal of the switch 71 is comparatively high. Therefore, the malfunction causing such a noise can be reduced.

### Fourth Embodiment

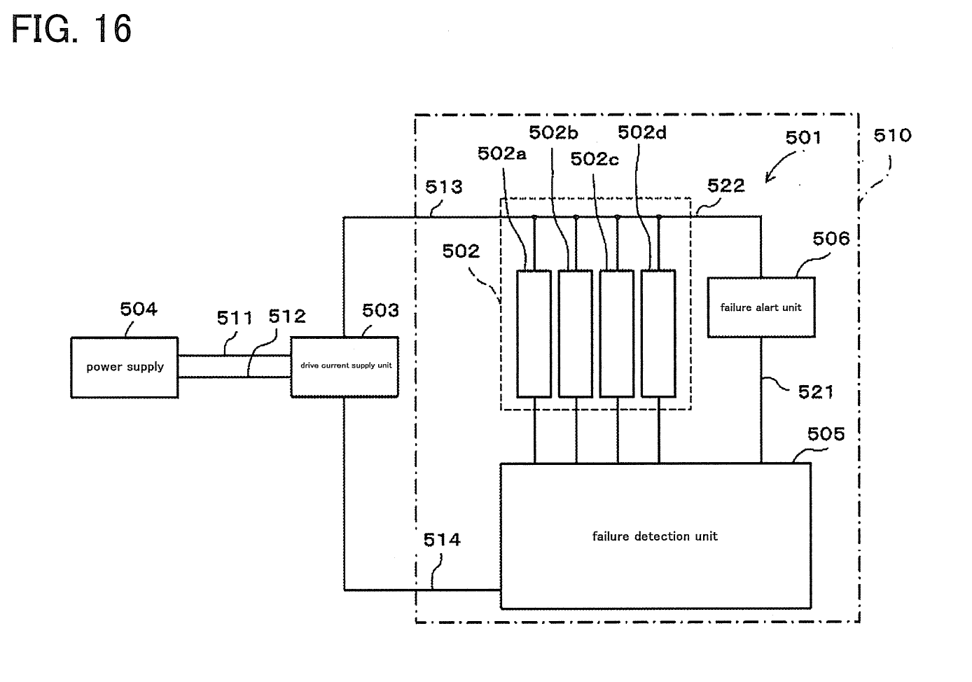

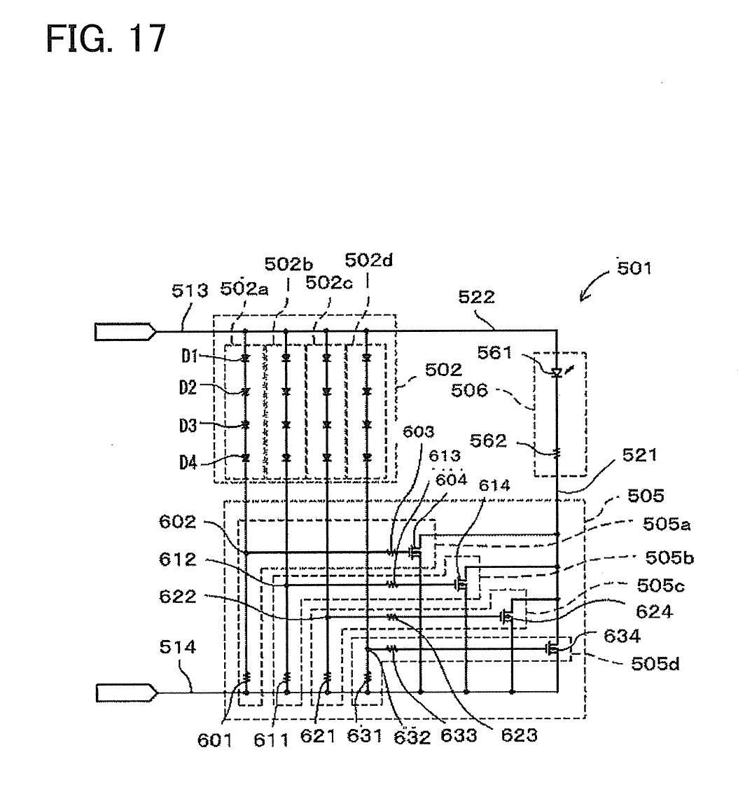

Next, a description will be given of a lighting device 510 according to a fourth embodiment of the present invention with reference to FIGS. 16 and 17. FIG. 16 is a block diagram showing a configuration of the LED lighting device and FIG. 17 is a circuit diagram showing main units of an LED lighting circuit in the LED lighting device.

The following will make description with reference to FIG. 16. The lighting device 510 includes an LED lighting circuit 501 and is mounted in a railroad passenger car. The LED lighting circuit 501 includes a light emitting unit 502 including LED circuits 502a, 502b, 502c, and 502d which are connected in parallel, a drive current supply unit 503 that is connected to the light emitting unit 502 via a power supply interconnection 514 to supply the light emitting unit 502 with a predetermined DC current, a failure detection unit 505 that is connected to the light emitting unit 502 and the drive current supply unit 503 to detect the occurrence of a failure on the LED circuits 502a through 502d, and a failure alert unit 506 that is connected in parallel with the LED circuits 502a through 502d to notify the failure occurrence based on a result of the detection by the failure detection unit 505. Further, to the drive current supply unit 503, a power supply 504 is connected that supplies power to the LED lighting circuit 501 from an outside.

As shown in FIG. 17, an LED circuit 502a is composed of four series-connected LEDs of D1 through D4. LED circuits 502b through 502d are each composed in a manner similar to the LED circuit 502a. Therefore, the light emitting unit 502 is composed of a parallel connection of the four LED circuits 502a through 502d in each of which the four LEDs are connected in series.

The failure detection unit 505 is composed of the voltage detection circuits 505a through 505d which are connected in parallel. The voltage detection circuit 505a includes a first resistor 601 which is connected in series with the LED circuit 502a, an FET 604, which is an N-channel MOSFET (detection unit, semiconductor switching element) which branches off from a node 602 inserted between the LED circuit 502a and the first resistor 601 and whose gate is connected in parallel with the first resistor 601, and a second resistor 603 which is disposed between the FET 604 and the node 602. Similarly, the voltage detection circuit 505b includes a first resistor 611, an FET 614 which branches off from a node 612 and whose gate is connected in parallel with the first resistor 611, and a second resistor 613 which is disposed between the FET 614 and the node 612. Further, similarly, the voltage detection circuit 505c includes a first resistor 621, an FET 624 which branches off from a node 622 and whose gate is connected in parallel with the first resistor 621, and a second resistor 623 which is disposed between the FET 624 and the node 622. Further, similarly, the voltage detection circuit 505d includes a first resistor 631, an FET 634 which branches off from a node 632 and whose gate is connected in parallel with the first resistor 631, and a second resistor 633 which is disposed between the FET 634 and the node 632.

To the LED circuits 502a through 502d, the voltage detection circuits 505a through 505d in the failure detection unit 505 are connected respectively. The voltage detection circuit 505a is disposed between the LED circuit 502a and the power supply interconnection 514. The voltage detection circuit 505b is disposed between the LED circuit 502b and the power supply interconnection 514. The voltage detection circuit 505c is disposed between the LED circuit 502c and the power supply interconnection 514. The voltage detection circuit 505d is disposed between the LED circuit 502d and the power supply interconnection 514. The FET 604 has its gate connected to the second resistor 603, its drain connected to the failure alert unit 506 via a signal interconnection 521, and its source connected to the power supply interconnection 514. In a manner similar to the LED circuit 502a, in the LED circuits 502b through 502d also, the FET 614 has its gate connected to the second resistor 613, its drain connected to the failure alert unit 506 via the signal interconnection 521, and its source connected to the power supply interconnection 514. The FET 624 has its gate connected to the second resistor 623, its drain connected to the failure alert unit 506 via the signal interconnection 521, and its source connected to the power supply interconnection 514. The FET 634 has its gate connected to the second resistor 633, its drain connected to the failure alert unit 506 via the signal interconnection 521, and its source connected to the power supply interconnection 514.

The FETs 604, 614, 624, and 634 are set to be in the state of non-continuity if the second resistors 603, 613, 623, and 633 are all sufficiently higher in resistance value than the first resistors 601, 611, 621, and 631 to permit the drive current supply unit 503 to supply a rated DC current so that the LEDs in the LED circuits 502a through 502d may function normally.

The failure alert unit 506 includes a warning display LED 561 and a current limiting resistor 562 which are connected in series and is connected to the light emitting unit 502 (power supply interconnection 513) via the signal interconnection 521 and to the voltage detection unit 505 via the signal interconnection 521. If any one of the FETs 604, 614, 624, and 634 enters the state of continuity so that a current may flow to the failure alert unit 506, the current is limited by the current limiting resistor 562 to prevent the warning display LED 561 from being damaged by an overcurrent.

The following will describe the ordinary operating states of the voltage detection circuit 505a with reference to the LED circuit 502a and the voltage detection circuit 505a as an example. When the LED circuit 502a is in the normal state and if a predetermined current is supplied from the drive current supply unit 503, a voltage across the LED circuit 502a takes on a predetermined value to light the LEDs D1 through D4. In this case, a resistance value R2 of the second resistor 603 is sufficiently higher than a resistance value R1 of the first resistor 601 and a voltage applied on the gate of the FET 604 is lower than the threshold value at which the FET 604 enters the state of continuity, so that no current flows between the drain and the source of the FET 604; therefore, the warning display LED 561 in the failure alert unit 506 is not lit.

Next, a description will be given of the operating states of the LED circuits 502a through 502d and the voltage detection circuits 505a through 505d upon occurrence of a short-circuit failure on the LEDs in the light emitting unit 502 with reference to the LED circuit 502a and the voltage detection circuit 505a as an example. If at least one of the LEDs D1 through D4 encounters a short-circuit failure, the internal impedance of the LED falls to decrease the voltage across the relevant LED circuit. Since the voltage detection circuit 505a is connected in series with the LED circuit 502a, a current flowing to the voltage detection circuit 505a increases. The rise in current flowing through the voltage detection circuit 505a raises a potential at the node 602. The voltage across the second resistor 603 rises to raise the voltage applied on the gate of the FET 604 also. If the voltage on the gate of the FET 604 exceeds its predetermined threshold voltage, the FET 604 enters the state of continuity between its drain and source so that a current may flow through it, thereby lighting the warning display LED 561 in the failure alert unit 506.

As the current flowing through the voltage detection circuit 505a increases to raise the voltages across the first resistor 601 and the second resistor 603, the voltage at the gate of the FET 604 is determined in accordance with the ratio between the resistance value R1 of the first resistor 601 and the second resistance value R2 of the second resistor 603. That is, the relatively larger the resistance value R1 of the first resistor 601 becomes with respect to the resistance value R2 of the second resistor 603, the more easily the voltage on the gate of the FET 604 rises in excess of the threshold voltage. The higher the resistance value R1 of the first resistor 601 becomes, the higher the sensitivity to detect the short-circuit failure on the LEDs D1 through D4 becomes. The higher the resistance value R2 of the second resistor 603 becomes, the lower the sensitivity to detect the short-circuit failure on the LEDs D1 through D4 becomes. If the detection sensitivity is high, the current detection circuit 505a is sensitive to the occurrence of a short-circuit failure on the LEDs, so that the failure alert unit 506 raises an alert upon the occurrence of a short-circuit failure even on a relatively small number of the LEDs. If the detection sensitivity to the short-circuit failure is low, the failure on the LEDs needs to go on to some extent until the failure alert unit 506 raises an alert. Accordingly, it is possible to preset the detection sensitivity in accordance with the ratio between the resistance values of the first resistor 601 and the second resistor 603 so that the failure alert unit 506 may raise an alert in accordance with the degree of the failure on the LED circuit 502a which indicates how many of the LEDs have encountered a short-circuit failure.

The LED circuits 502b through 502d are equivalent to the LED circuit 502a and the voltage detection circuits 505b through 505d are equivalent to the voltage detection circuit 505a in circuit configuration, so that the operating states of the voltage detection circuits 505b through 505d in both cases where they operate ordinarily and upon occurrence of a short-circuit failure are identical with those of the voltage detection circuit 505a. The voltage detection circuits 505a through 505d are arranged in parallel with each other and, therefore, operate independently of each other to detect the occurrence of a short-circuit failure on the LED circuits 502a through 502d which are series-connected thereto respectively.

As described hereinabove, in the LED lighting circuit 501 according to the fourth embodiment of the present invention, the voltage detection circuits 505a through 505d are connected in series with the LED circuits 502a through 502d respectively to directly detect currents flowing through the LED circuits 502a through 502d respectively and, therefore, can detect a short-circuit failure on the LEDs with a small possibility of detecting a change due to the other factors mistakenly.

Further, since the voltage detection circuits 505a through 505d detect short-circuit failures on the parallel-connected LED circuits 502a through 502d independently of each other, it is possible to easily identify which one of the LED circuits 502a through 502d has failed by checking whether a current is flowing between the drain and the source of the FET in each of the voltage detection circuits 505a through 505d.

Further, in the LED lighting circuit 501, if the FET enters the state of continuity to permit a current to flow to the failure alert unit 506, the warning display LED 561 lights up, thereby enabling giving warning in a visually recognizable manner.

Further, in the lighting device 510, if the LEDs of the light source encounter a short-circuit failure, the failure is detected by the voltage detection circuits 505a through 505d incorporated in the light device 510, so that based on a result of the detection, the warning display LED 561 in the failure alert unit 506 lights up. By suggesting the need to repair or replace the lighting device by lighting the warning display LED 561 before the LEDs fail in a derivative manner owing to the occurrence of an overcurrent caused by a short-circuit failure, it is possible to prevent the overcurrent due to the short-circuit failure from further expanding hazards of the failure. Further, even if the warning display LED 561 lights up, the device is not immediately rendered unusable and, therefore, can also be used continually for the time being.

Moreover, the LED lighting circuit 501 does not use a computer or an integrated circuit (IC) but is composed of simple analog circuits and, therefore, can be manufactured inexpensively. Further, it can be easily inspected and repaired in maintenance.

Further, a reference value for deciding a drop in voltage of the LED circuits 502a through 502d is determined based on the resistance values of the first resistors 601, 611, 621, and 631, so that by adjusting the resistance values of the first resistors 601, 611, 621, and 631, it is possible to set a criterion for the lighting of the warning display LED 561, that is, a reference value of the minimum number of the failed LEDs required to raise an alert. Accordingly, it is possible to appropriately set the accuracy of short-circuit failure detection in accordance with the characteristics or the number of the LEDs or the characteristics of the lighting apparatus.

In the fourth embodiment described hereinabove, the drive current supply unit 503 is a constant current source for supplying a predetermined current, and the light emitting unit 502 supplied with a drive current from the drive current supply unit 503 includes the plurality of LED circuits 502a through 502d. Accordingly, if any one of the four LEDs D1 through D4 in the LED circuit 502a, for example, the LED D3 encounters a short-circuit failure, the following phenomenon may occur.
If the internal impedance of the short-circuit-failed LED D3 decreases almost to zero, the internal impedance of the LED circuit 502a including this LED D3 falls below those of the other normal LED circuits 502b through 502d, thereby increasing the drive current flowing through the LED circuit 502a.
Then, as the drive current increases, a voltage across the LED circuit 502a including the short-circuit-failed LED D3 increases, which LED circuit 502a is connected in parallel with the other normal LED circuits 502b through 502d. Accordingly, the voltage across the LED circuit 502a becomes equal to each of the voltages across the LED circuits 502b through 502d.

From those, the following Equation (1) is established by assuming the forward voltage of the normal LED to be Vf, its forward current (=drive current) to be I, the forward voltage of the faulty LED having encountered a short-circuit failure etc. to be Vf′, its forward current to be I′, the number of the LEDs of an LED circuit 2a etc. to be n, the number of the faulty LED having encountered a short-circuit failure etc. to be m, and the resistance value of a first resistor 101 etc. connected in series with the LED circuit 2a etc. to be R1. The LED's forward voltages Vf and Vf′ and forward currents I and I′ are based on a data sheet provided by the manufacturer etc. of this LED.

Equation (1)

n×Vf+R1×I=(n−m)×Vf′+R1×I′ (1)

Equation (1) can be modified into the following Equation (2) for obtaining the number m of the faulty LEDs having encountered a short-circuit failure etc.

Equation (2)

m=[n×(Vf′−Vf)+R1×(I′−I)]/Vf′ (2)

In such a manner, for example, by obtaining each forward voltage (Vf′) corresponding to each current value of the drive current, which is the LED's forward current, as a two-dimensional map to be stored in a storage space by use of a memory IC etc. and providing a current sensor that can detect each drive current I′ flowing through each of the LED circuits 502a through 502d upon occurrence of a failure or a voltage sensor detecting a voltage into which this drive current is converted, the number (m) of the faulty LEDs having encountered the short-circuit failure etc. can be calculated with a microcomputer etc. by using Equation (2). Then, based on the thus calculated number (m), the drive current supply unit 3 can be configured so that the value of the drive current supplied from the drive current supply unit 3 to the light emitting unit 2 can be decreased, to decrease the drive current in accordance with the number of the short-circuit-failed LEDs, thereby preventing an overcurrent in excess of an appropriate current value from flowing to the other normal LEDs. Although it is necessary to add a logic circuit by use of a microcomputer etc. to the first embodiment's configuration in order to realize such configurations, the number of the short-circuit-failed LEDs can also be detected accurately, thereby further improving the accuracy in detection of short-circuits.

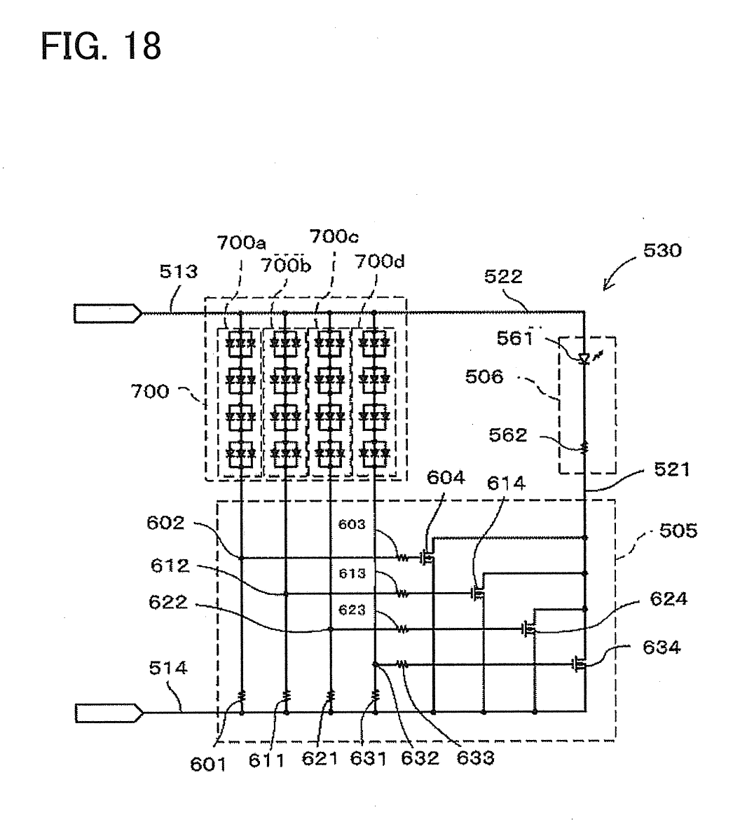

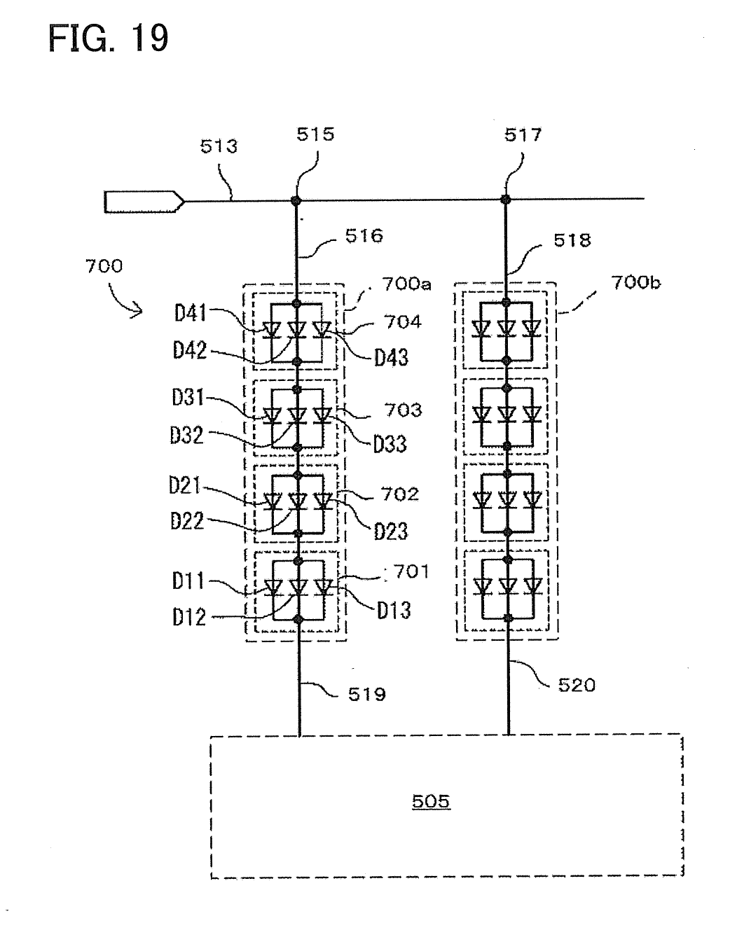

Next, a description will be given of an LED lighting device 530 according to a fifth embodiment of the present invention with reference to FIGS. 18 and 19. Similar to the LED lighting circuit 501, the LED lighting circuit 530 is for use in a lighting fitting mounted in a railroad passenger car. As shown in FIG. 18, the LED lighting circuit 530 is the same as the LED lighting circuit 501 except that it includes a light emitting unit 700 in place of the light emitting unit 502 of the LED lighting circuit 501. Therefore, identical reference numerals are given to substantially identical components in FIGS. 18 and 17, and only the light emitting unit 700 will be described below.

The light emitting unit 700 is composed of a parallel connection of LED circuits 700a, 700b, 700c, and 700d. As shown in FIG. 19, in the LED circuit 700a, LED groups 701 through 704 are connected in series each of which is composed of a parallel connection of three LEDs. The LED group 701 is composed of LEDs D11 through D13, the LED group 702 is composed of LEDs D21 through D23, the LED group 703 is composed of LEDs D31 through D33, and the LED group 704 is composed of LEDs D41 through D43. The LED circuits 700b through 700d each have the same configuration as the LED circuit 700a and its description will not be repeated here.

If any one of the LEDs of D11 through D43 encounters a short-circuit failure, the voltage across one of the LED circuits 700a through 700d that includes the short-circuit-failed LED falls. In the light emitting unit 700 including a total of the 48 LEDs, voltage detection circuits 705a through 705d are mounted for the LED circuits 700a through 700d respectively, so that it is necessary only to monitor a change in voltage on the 12 LEDs not on all of the 48 LEDs, thereby reducing the possibility of malfunctioning even with a simple circuit configuration. Therefore, the LED lighting circuit 530 enables more accurate abnormal voltage detection than a case where one voltage detection circuit is mounted for the entirety of the light emitting unit 700.

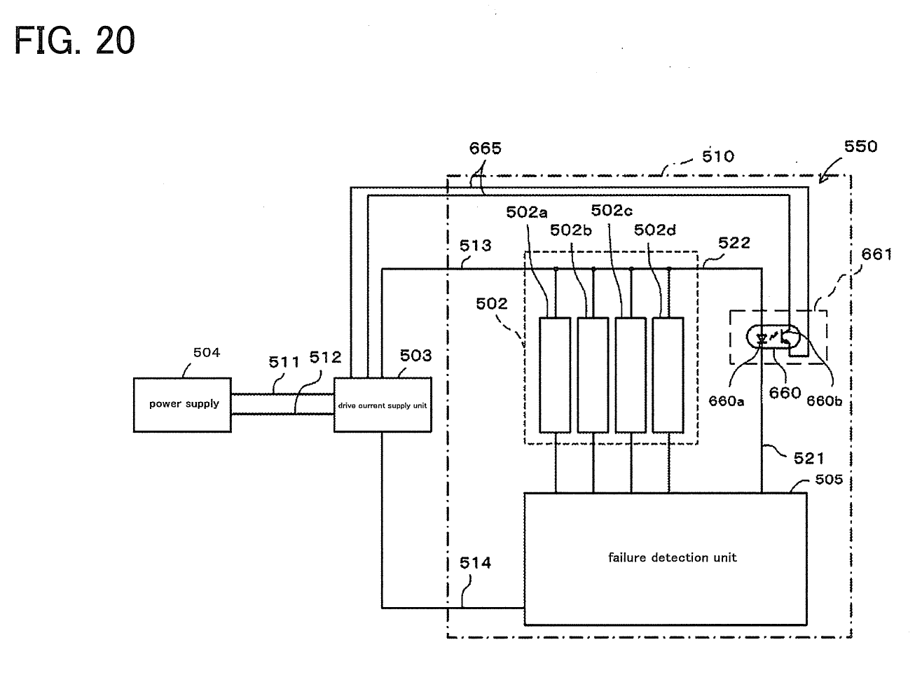

Subsequently, a description will be given of an LED lighting device 540 according to a sixth embodiment of the present invention with reference to FIG. 20. The LED lighting circuit 540 shown in FIG. 20 has introduced bipolar transistors in place of the FETs 604, 614, 624, and 634 in the LED lighting circuit 501 of the fourth embodiment described with reference to FIG. 17. Therefore, identical reference numerals are given to substantially identical components in FIGS. 20 and 17, and description thereof will not be repeated here.

In the LED lighting circuit 540, a failure detection unit 640 includes a parallel connection of voltage detection circuits 640a through 640d. For example, the voltage detection circuit 640a includes a first resistor 641 which is connected in series with the LED circuit 502a, a TR 644, which is an NPN-type transistor (detection unit, semiconductor switching element) which branches off from a node 642 inserted between the LED circuit 502a and the first resistor 641 and whose base is connected in parallel with the first resistor 641, and a second resistor 643 which is disposed between the TR 644 and the node 642. Similarly, the voltage detection circuits 640b, 640c, and 640d each include a first resistor, a second resistor, and an NPN-type transistor. Similar to the first resistor 601 described in the fourth embodiment, the first resistor 641 has its resistance value set based on the value of a drive current flowing through the LED circuit 502a. Further, the bipolar transistor has lower input impedance than the MOSFET, so that correspondingly the resistance value of the second resistor 643 is set higher than the second resistor 603 described in the fourth embodiment. In such a manner, the bipolar transistors can be used also to make up the failure detection unit 640 that functions in almost the same manner as the failure detection unit 505 in the fourth embodiment.

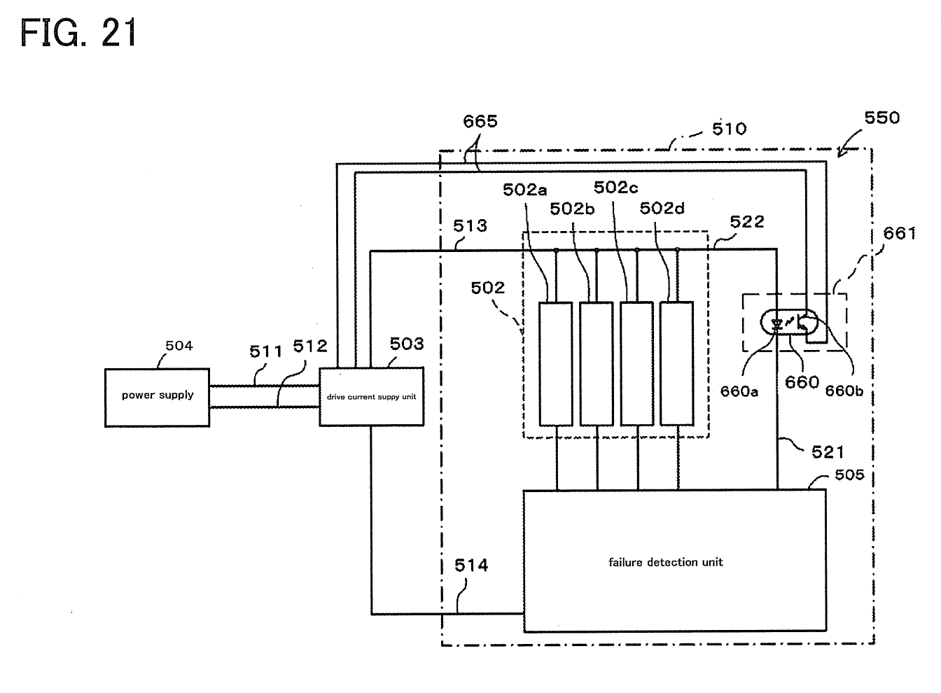

Further, a description will be given of an LED lighting device 550 according to a seventh embodiment of the present invention with reference to FIG. 21. The LED lighting circuit 550 shown in FIG. 21 has a configuration in which the control signal can be output from the failure alert unit 506 in the fourth embodiment described with reference to FIG. 16 and returned to the drive current supply unit 503, that is, a feedback-controllable configuration. Therefore, identical reference numerals are given to identical components in FIGS. 21 and 16, and description thereof will not be repeated here.

In the LED lighting circuit 550, the warning display LED 561 based on the failure alert unit 506 in the LED lighting circuit 501 described in the fourth embodiment may be replaced by (or combined with) a photo-coupler 660 that can output the control signal decreasing the drive current to the drive current supply unit 503 via a signal interconnection 665, as a failure alert unit 661. In this case, the photo-coupler 660 has its input side 660a connected to the failure detection unit 505 via the signal interconnection 521 and its output side 660b connected to the drive current supply unit 503 via the signal interconnection 665. Further, the drive current supply unit 503 needs to include an output adjustment circuit etc. for decreasing the drive current supplied to the light emitting unit 502 down to a predetermined current value if it receives this control signal. Although the photo-coupler 660 has been used in the configuration shown in FIG. 21, a configuration may be employed in which a photo-sensor (for example, photo-transistor, photo-diode, or cadmium sulfide cell (Cds)) capable of detecting lighting of the warning display LED 561 shown in FIG. 17 is used to detect lighting of the warning display LED 561 so that the resultant detected signal may be output as the control signal to a drive current supply unit 503 via a signal interconnection 165. In such a manner, it is possible to suppress an overcurrent occurring with a short-circuit failure, thereby preventing damage etc. of the semiconductor elements from further expanding hazards.

The fourth through seventh embodiments have embodied the following technical ideas.

(Technical Idea A)

An LED lighting circuit mounted in a lighting device having LEDs as a light source, the circuit including:

a light emitting unit that includes a plurality of LED circuits for supplying drive currents to a plurality of LEDs connected in series or parallel;

a failure detection unit that detects whether each of the drive currents flowing through the plurality of LED circuits is equal to or larger than a predetermined fault current value for those LED circuits as a whole; and

a failure alert unit that performs a predetermined alert operation if the failure alert unit detects that at least one of the drive currents is equal to or larger than the predetermined fault current value.

(Technical Idea B)

The LED lighting circuit according to the technical idea A, in which the failure detection unit includes for the plurality of LED circuits as a whole:

a first resistor that is connected in series with the LED circuit so that the drive current may flow through itself;

a second resistor that is connected to a higher-potential side of the first resistor so that it can take out a voltage which occurs across the first resistor owing to the drive current; and

a detection unit that detects whether a detected voltage which is proportional to the drive current and determined by the first resistor and the second resistor is equal to or larger than a predetermined voltage value, in which the detection unit decides that the drive current is equal to or larger than the fault current value if the detected voltage is equal to or larger than the predetermined voltage value.

(Technical Idea C)

The LED lighting circuit according to the technical idea B, in which the detection unit is a semiconductor switching element that includes a control terminal, an input terminal, and an output terminal, in which if the detected voltage input to the control terminal is equal to or larger than a predetermined threshold voltage, the state of continuity is established between the input terminal and the output terminal, whereas if the detected voltage is less than the predetermined threshold voltage, the state of non-continuity is established between the input terminal and the output terminal.

(Technical Idea D)

The LED lighting circuit according to any one of the technical ideas A through C, in which the failure alert unit includes a warning display LED which indicates alert state and lights the warning display LED as the predetermined alert operation.

(Technical Idea E)

The LED lighting circuit according to any one of the technical ideas A through C, in which the failure alert unit includes a photo-coupler which is connected to the drive current supply unit supplying the drive currents so that it can output a control signal that decreases the drive currents and permits the photo-coupler to output the control signal as the predetermined alert operation.

The present invention is not exclusively stricted to the embodiment described so far but may be changed into the following modes.

The fluorescent lamp 1 which receives control of lighting and putting out lights may be plural. The fluorescence tube may not be limited to a straight tube type but in a compact form, such as an annulus and the U shaped type.

The power supply voltage Vcc may be the alternating current voltage obtained not only from direct-current voltage but from commercial power.

The transformer 19 is not limited to the kind with a primary side consists of two winding. For example, as for the transformer 19, a primary side may consist of one winding.

The inverter circuit 18 is not limited to what consists of a push pull circuit and may be other circuits. Either of a full bridged circuit and a half bridged circuit may be applied for the inverter circuit 18.

The capacitor 24 may not only be formed in the second winding terminal 22b side of the secondary winding 22, but may be formed in the first winding terminal 22a side, for example.

The fluorescent lamp drive 2 may be equipped in vehicles, not only a railroad but a car.

In the first and second embodiments, a direct-current interception means is not limited only to the capacitor 24. The circuit by combination of other elements such as coils may be sufficient as a direct-current interception means, for example.

In the first and the second embodiments, the capacitor 24 may be not only prepared in the second winding terminal 22b side of the secondary winding 22, but formed in the first winding terminal 22a side, for example.

In the first and second embodiments, the disconnection detecting circuit 27 is not limited to the combination of four resistance 28 through 31 connected in series and the capacitor 32. As long as it can detect disconnection, what kind of device may be used for the malfunction detecting circuit.

In the first and second embodiments, the disconnection monitoring unit 33 which is a circuit monitoring disconnection does not need to be formed in the switch circuit 16. For example, it may be included in the oscillating circuit 17. The arrangement of the disconnection monitoring unit 33 may be changed suitably.

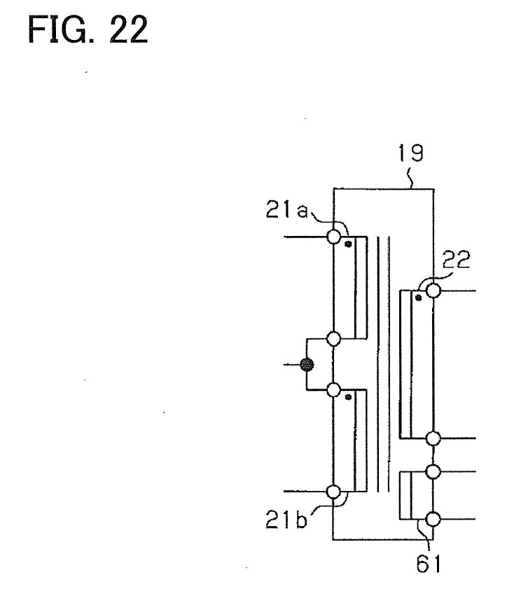

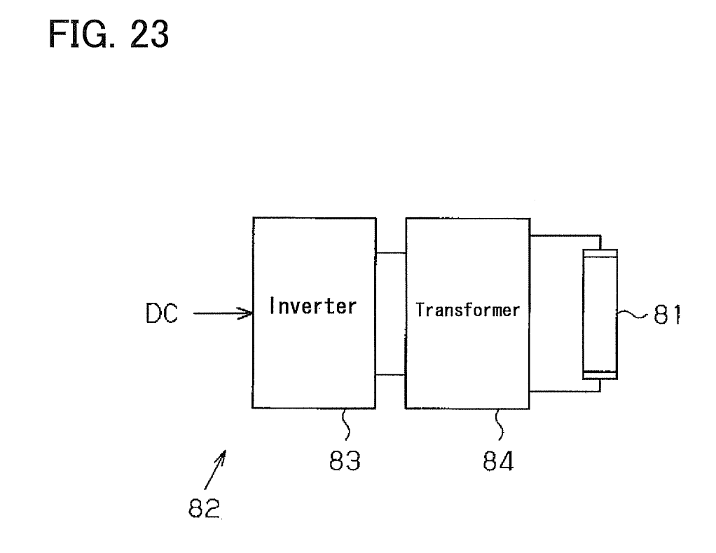

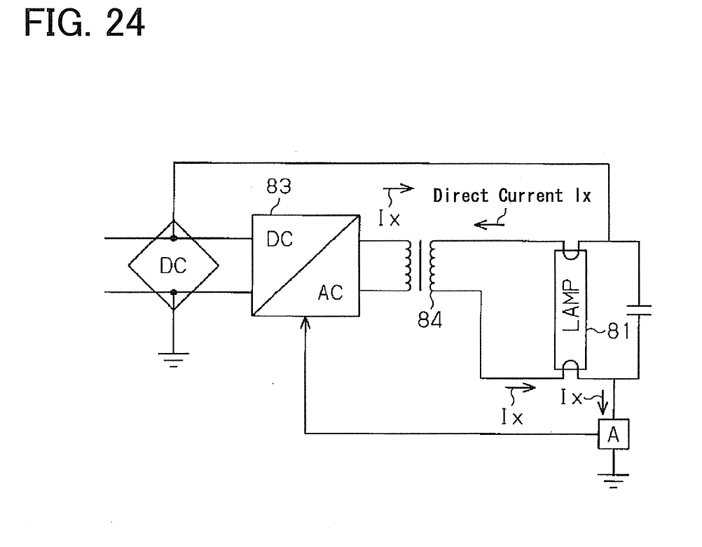

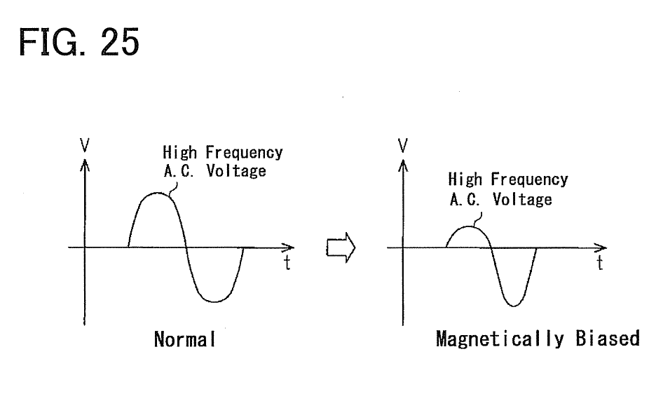

In the first and second embodiments, the tube failure detection means may be other than the combination of two or more resistance 35 through 37 and the capacitor 38. For example, as shown in FIG. 22, the auxiliary winding 61 prepared in the transformer 19 may work as the tube failure detection means.

In the first and second embodiments, when substituting the auxiliary winding 61 of the transformer 19 for a tube failure detection means, the auxiliary winding 61 may be disposed not only in the transformer 19 but in the choke coil 23.

In the first and second embodiments, the power supply voltage Vcc may be not only in direct-current voltage but the alternating current voltage obtained from commercial electric power source.

In the first and second embodiments, the structure of the transformer 19 is not restricted to the one with the primary side consists of two winding. For example, the structure where a primary side consists of one winding may be sufficient as the transformer 19.

In the first and second embodiments, the circuits other than what consists of a push pull circuit may also be used for the inverter circuit 18.

Either of a full bridged circuit and a half bridged circuit may be used for the inverter circuit 18.

In the first and second embodiments, when the abnormality in the tube or overheating occurs, it may be preferable to stop the power supply by the switch circuit 16 as well as to stop the oscillation operation of the oscillating circuit 17.

In the first and second embodiments, although the overheating detection circuit 13 (overheating detection circuit unit 56) is disposed in the fluorescent lamp drive 2 and 112 side, the overheating detection circuit 13 is attached to the fluorescent lamp 1, and it may detect overheating of the fluorescent lamp 1 directly, for example.

In the first and second embodiments, the number of the fluorescent lamp 1 controlled may be two or more.

In the first and second embodiments, the overheating notification unit 14 and the operation notice unit 20 are not limited to consisting of LED. For example, it may be substituted by the display which can display a character and a pattern, and the display may notify abnormalities more visually.

In the first and second embodiments, the fluorescent lamp drive 2 and 112 may be disposed not only in a railroad but in a car.

Although all of the above fourth through seventh embodiments have been described with reference to the example where the four LED circuits have been connected in parallel, the present invention is not limited to it; the number of the connected LED circuits may be three or less or five or more. Further, although in the second embodiment, the LED group includes the three LEDs connecting in parallel to each other, the present invention is not limited to it; the number of the LEDs included in the LED group and how to connect them may be different. Further, in contrast to the connected plurality of LED circuits having the same configuration, the LED circuits having the different configurations may be connected in parallel.

Although the above fourth through seventh embodiments have been described with the reference to the example where one warning display LED 561 is arranged in parallel with each of the LED circuits to collectively indicate results of detection by the voltage detection circuits 505a through 505d, the present invention is not limited to it each warning display LED may be provided for each of the voltage detection circuits 505a through 505d. In this configuration, the warning display LED, and the LED circuit and the voltage detection circuit mutually correspond in a one-to-one relationship, so that it is possible to quickly identify the LED circuit that has encountered a short-circuit failure.

In the technical ideas of the fourth through seventh embodiments, the LED lighting circuit can be used in applications other than a vehicle-mounted lighting device such as the lighting device 510. In one example, it can be applied to a flash lamp or a helmet-mounted portable light. In this case, a failure having occurred on any one of the LEDs can be immediately detected at an early stage, so that it is possible to prevent abrupt malfunction in a risky situation such as, for example, a tunnel or a disaster site from triggering an accident owing to insufficient illumination.

Further, in the technical ideas of the fourth through seventh embodiments, the LED lighting circuit may “further include a photo-sensor that is provided in the drive current supply unit and detects lighting of the warning display LED and an output adjustment circuit that controls an output of the drive current supply unit based on a result of the detection by the photo-sensor so that feedback control may be conducted to decrease a DC current output from the drive current supply unit based on the detection of the lighting of the warning display LED by the photo-sensor”.

In this configuration, if the LED encounters a short-circuit failure, the lighting of the warning display LED is detected by the photo-sensor. Based on a result of the detection, the output adjustment circuit in the drive current supply unit decreases a DC current output to quickly inhibit the occurrence of an overcurrent. Accordingly, it is possible to prevent damage of the LED circuit owing to the short-circuit failure from developing, thereby improving security.

Further, in the technical ideas of the fourth through seventh embodiments, the LED lighting circuit may “be mounted in a lighting device having LEDs as its light source and include a light emitting unit including a plurality of LED circuits supplying drive currents to a plurality of LEDs connected in series or parallel, a current detection unit that detects the value of a current flowing through the plurality of LED circuits, a calculation unit that calculates the number of the short-circuit-failed ones of the plurality of LEDs based on the current value of each of the drive currents for each of the LED circuits, and a control unit that controls a current amount of the drive current supplied to the plurality of LEDs from the LED circuits based on the number of the faulty LEDs calculated for each of the LED circuits”.

In this configuration, it is possible to prevent an overcurrent in excess of an appropriate current value from flowing to the other normal LEDs by decreasing the drive current corresponding to the number of the short-circuit-failed LEDs, thereby further improving the accuracy in short-circuit detection because the number of the short-circuit-failed LEDs can also be detected accurately.

Next, technical ideas and their benefits which can be grasped from the above-mentioned embodiment and other examples are described below.

(Technical Idea G)

According to the present invention, it may further comprise a fluorescent lamp preheating execution means to make this fluorescent lamp turn on by the preheating current which flows through the fluorescent lamp at the early stage of lighting of the fluorescent lamp. By the way, since there is a tendency to extend life-span if a fluorescent lamp is made to discharge with preheating current, it becomes possible to lengthen the life of a fluorescent lamp by this idea.

(Technical Idea H)

In addition to the technical idea G, when the fluorescent lamp carries out the preheating operation, it has a forced-termination suspending means by which the function of forced termination becomes invalid temporarily. By the way, since operation at the time of preheating operation is unstable, the fluorescent lamp may be momentarily determined to be in the abnormal state, and be forced to terminate. In this example, the function of forced termination is temporarily suspended at the time of preheating operation. Therefore, despite of the function of forced termination, the fluorescent lamp can perform preheating operation without any conflict.

The present invention can be used for the lighting control field of a lighting installation, especially the lighting control field of a fluorescent lamp.

1. An LED lighting circuit mounted in a lighting device that has a plurality of LEDs connected in series or parallel as a light source comprising:
a light emitting unit that includes a plurality of LED circuits supplying drive currents to the plurality of the LEDs;
a failure detection unit that detects whether the drive currents flowing through each of the LED circuit is equal to or larger than a predetermined fault current value respectively; and
a failure alert unit that performs a predetermined alert operation if the failure alert unit detects that at least one of the drive currents is equal to or larger than the predetermined fault current value.

2. The LED lighting circuit according to claim 1, wherein each LED circuits comprises at least one failure detection unit;
the at least one failure detection unit further comprising:
a first resistor that is connected in series with the LED circuit so that the drive current may flow through itself;
a second resistor that is connected to a higher-potential side of the first resistor so that it can take out a voltage which occurs across the first resistor owing to the drive current; and
a detection unit that detects whether a voltage which is proportional to the drive current and determined by the first resistor and the second resistor is equal to or larger than a predetermined voltage value,
wherein the detection unit determines that the drive current is equal to or larger than the fault current value when the detected voltage is equal to or larger than the predetermined voltage value.

3. The LED lighting circuit according to claim 2, wherein the detection unit is semiconductor switching element further comprising:
a control terminal;
an input terminal; and
an output terminal;
wherein the state of continuity is established between the input terminal and the output terminal, when the detected voltage input to the control terminal is equal to or larger than a predetermined threshold voltage, and
wherein the state of non-continuity is established between the input terminal and the output terminal, if the detected voltage is less than the predetermined threshold voltage.

4. The LED lighting circuit according to claim 2, wherein the failure alert unit further comprising a warning display LED:
wherein the warning display LED lights the LED as the predetermined alert operation.

5. The LED lighting circuit according to claim 2, wherein the failure alert unit further comprising a photo-coupler,
the photo-coupler being connected to the drive current supply unit supplying the drive currents, and
the photo-coupler outputting a control signal that decreases the drive currents and permits the photo-coupler to output the control signal as the predetermined alert operation.

6. The lighting device that has LED as a light source comprising the LED light circuit according to claim 2.
